(19) United States
(12) Patent Application Publication
(10) Pub. No.: US 2004/0022516 A1
(43) Pub. Date: Feb. 5, 2004

(54) Image recording system and image recording reproducing apparatus

(75) Inventors: Yoshihide Yamashiro, Osaka (JP); Kei Tanimura, Hyogo (JP); Toshiaki Kawasaki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/621,318

(22) Filed: Jul. 18, 2003

(30) Foreign Application Priority Data
Jul. 19, 2002 (JP) 2002-210423
Jul. 19, 2002 (JP) 2002-210424

(51) Int. Cl. H04N 9/89

(52) U.S. Cl. 386/13

(57) ABSTRACT

A surveillance camera system includes a multiplexer. A camera switch circuit provided on the multiplexer selects each of a plurality of surveillance cameras in a time-division manner. An image processing circuit included in the multiplexer fetches a photographed image signal output from a selected surveillance camera, and adds VBI information having a recording bit of “1” to the photographed image signal at a timing according to a recording mode setting. An HDR recodes the photographed image signal in a hard disk when the recording bit included in the VBI information is “1”.

### BACKGROUND OF THE INVENTION

1. Field of the Invention

The present invention relates to an image recording system applicable to a surveillance camera system, for example. More specifically, the present invention relates to an image recording system which has a multiplexer for selectively outputting a plurality of image signals applied from a plurality of cameras and a recording apparatus for recording in a recording medium the image signals output from the multiplexer.

The present invention is also relates to an image recording reproducing apparatus applicable to a surveillance camera system. More specifically, the present invention relates to an image recording reproducing apparatus performing recording/reproducing of an image signal output from the surveillance camera.

2. Description of the Prior Art

In conventional such kind of surveillance camera, the multiplexer selects each of a plurality of cameras by a predetermined number of frames in a time-division manner and extracts in a predetermined cycle an image signal output from a selected surveillance camera. Then, a recording apparatus records the image signal output from the multiplexer in a recording medium such as a video tape. However, in the prior art, since the recording medium is a video tape, an extraction cycle of the image signal has to be fixed and therefore, it is impossible to arbitrarily change the extraction cycle every camera. That is, if the extraction cycle of the image signal is changed, it is impossible to adequately record the image signal.

Furthermore, in another conventional surveillance camera system, the image signal output from the surveillance camera is extracted at a predetermined cycle, and the extracted image signal is recorded on the recording medium such as a video tape. Because of the recording medium being the video tape, the extraction cycle of the image signal has to be fixed and therefore, it is impossible to arbitrarily change the extraction cycle for each camera. Herein, if utilizing as the recording medium a hard disk superior in random access characteristic, it is possible to arbitrarily change the extraction cycle of the image signal. However, merely change of the extraction cycle makes it impossible to reproduce the recorded image signal at a desired speed. Such a problem similarly occurs in a case the plurality of surveillance cameras are selected in a time-division manner and the extraction cycle of the image signal is made different from one camera to another.

### SUMMARY OF THE INVENTION

Therefore, it is a primary object of the present invention to provide an image recording system capable of precisely recording an arbitrary image signal onto a recording medium.

Another object of the present invention is to provide an image recording reproducing apparatus capable of reproducing an image signal from a recording medium at a desired speed irrespective of an extraction cycle of the image signal.

An image recording system according to the present invention comprises: a multiplexer for selectively outputting a plurality of image signals applied from a plurality of cameras; and a recording apparatus for recording the image signals output from the multiplexer in a recording medium, wherein the multiplexer includes a selector for selecting each of the plurality of cameras in a time-division manner, an applier for applying at an arbitrary timing a recording request signal to the image signal output from a camera selected by the selector, and the recording apparatus includes a recorder for recording, when the recording request signal is applied to the image signal output from the multiplexer, the image signal in the recording medium.

The multiplexer selectively outputs the plurality of image signals applied from the plurality of cameras, and the recording apparatus records the image signal output from the multiplexer in the recording medium. More specifically, the multiplexer selects each of the plurality of cameras in a time-division manner and adds at an arbitrary timing the recording request signal to the image signal output from the selected camera. The recorder, when the recording request signal is added to the image signal output from the multiplexer, records the image signal in the recording medium. Therefore, it is possible to precisely record only the arbitrary image signal in the recording medium.

In a case that the multiplexer accepts setting of a recording rate with respect to each of the plurality of cameras, the arbitrary timing is a timing according to the accepted setting of the recording rate.

In a case the multiplexer generates recording mode information indicative of any one of a pre-alarm recording or a post-alarm recording depending upon an occurring state of an alarm, the recording request signal includes the recording mode information.

Preferably, the recording medium has a pre-alarm area and a post-alarm area. At this time, the recorder detects the recording mode information from the recording request signal. Furthermore, when the detected recording mode information indicates the pre-alarm recording, the image signal is recorded in the pre-alarm area, and when the detected recording mode information indicates the post-alarm recording, the image signal is recorded in the post-alarm area.

The multiplexer may select a specific camera by priority when performing the post-alarm recording.

The image recording reproducing apparatus according to the preset invention comprises: an extractor for extracting an image signal of an arbitrary screen from image signals of a plurality of successive screens; a first recorder for recording the image signal extracted by the extractor; a detector for detecting a time difference value between a previous extraction timing by the extractor and a current extraction timing by the extractor; a second recorder for recording control information including the time difference value detected by the detector; and a reproducer for reproducing the image signal recorded by the first recorder at a timing based on the control information recorded by the second recorder.

When the image signal of the arbitrary screen is extracted from the image signals of the plurality of successive screens, the image signal is recorded by the first recorder. The detector detects the time difference value between the previous extraction timing by the extractor and the current extraction timing by the extractor, and the second recorder records the control information including the detected time difference value. The image signal recorded by the first recorder is reproduced by the reproducer at the timing based on the control information recorded by the second recorder. This makes it possible to reproduce the image signal from the recording medium at a desired speed irrespective of the extraction cycle of the image signal.

In a case of selecting the plurality of cameras by the selector in the time-division manner, the image signals of the plurality of successive screens are image signals output from the camera selected by the selector.

The second recorder preferably relates the control information including the time difference value to the image signal currently extracted by the extractor.

More preferably, when reproducing an image signal of a current screen, a first difference value included in the control information related to an image signal of a next screen is detected by a first difference value detector, and a second difference value included in the control information multiplexed onto an image signal of a current screen is detected by a second difference value detector. The reproducer reproduces the image signal of the next screen at a time that a time period corresponding to the first difference value has elapsed when performing normal speed reproduction in a forward direction, and reproduces the image signal of the previous screen at a time that a time period corresponding to the second difference value has elapsed when performing normal speed reproduction in a reverse direction.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is a block diagram showing one example of a configuration of a multiplexer;

FIG. 3 is an illustrative view showing a part of an operation of the multiplexer;

FIG. 4 is an illustrative view showing one example of a recording mode setting;

FIG. 5 is an illustrative view showing one example of a program recording setting;

FIG. 6 is an illustrative view showing a part of an operation of the multiplexer according to the settings shown in FIG. 4 and FIG. 5;

FIG. 7 is an illustrative view showing another example of the recording mode setting;

FIG. 8 is an illustrative view showing another example of the program recording setting;

FIG. 9 is an illustrative view showing the other example of the program recording setting;

FIG. 10 is an illustrative view showing a part of an operation of the multiplexer according to the settings shown in FIG. 7 to FIG. 9;

FIG. 11 is an illustrative view showing a part of an operation of the multiplexer according to the setting shown in FIG. 4 or FIG. 7;

FIG. 12 is a block diagram showing one example of a configuration of an HDR;

FIG. 13 (A) is an illustrative view showing a mapping state of an area for a recording process formed on an SDRAM;

FIG. 13 (B) is an illustrative view showing a mapping state of an area for a reproducing process formed on the SDRAM;

FIG. 14 is an illustrative view showing one example of a structure of a hard disk;

FIG. 15 (A) is an illustrative view showing one example of a structure of filed data recorded on the hard disk;

FIG. 15 (B) is an illustrative view showing one example of a structure of tag data recorded on the hard disk;

FIG. 16 is a flowchart showing a part of an operation of the multiplexer;

FIG. 17 is a flowchart showing another part of the operation of the multiplexer;

FIG. 18 is a flowchart showing the other part of the operation of the multiplexer;

FIG. 19 is a flowchart showing a part of an operation of the HDR;

FIG. 20 is a flowchart showing another part of the operation of the HDR;

FIG. 21 is a flowchart showing the other par of the operation of the HDR;

FIG. 22 is a flowchart showing a further part of the operation of the HDR;

FIG. 23 is a flowchart showing another part of the operation of the HDR;

FIG. 24 is a flowchart showing the other part of the operation of the HDR;

FIG. 25 is a flowchart showing a further part of the operation of the HDR;

FIG. 26 is a flowchart showing another part of the operation of the HDR;

FIG. 27 is a flowchart showing the other part of the operation of the HDR;

FIG. 28 is a flowchart showing a further part of the operation of the HDR;

FIG. 29 is a flowchart showing another part of the operation of the HDR;

FIG. 30 is a flowchart showing the other part of the operation of the HDR;

FIG. 31 is a flowchart showing a further part of the operation of the HDR;

FIG. 32 is a flowchart showing another part of the operation of the HDR;

FIG. 33 is a flowchart showing the other part of the operation of the HDR; and

FIG. 34 is a flowchart showing a further part of the operation of the HDR.

### DETAILED DESCRIPTION OF THE PREFERRED EMBODIMENTS

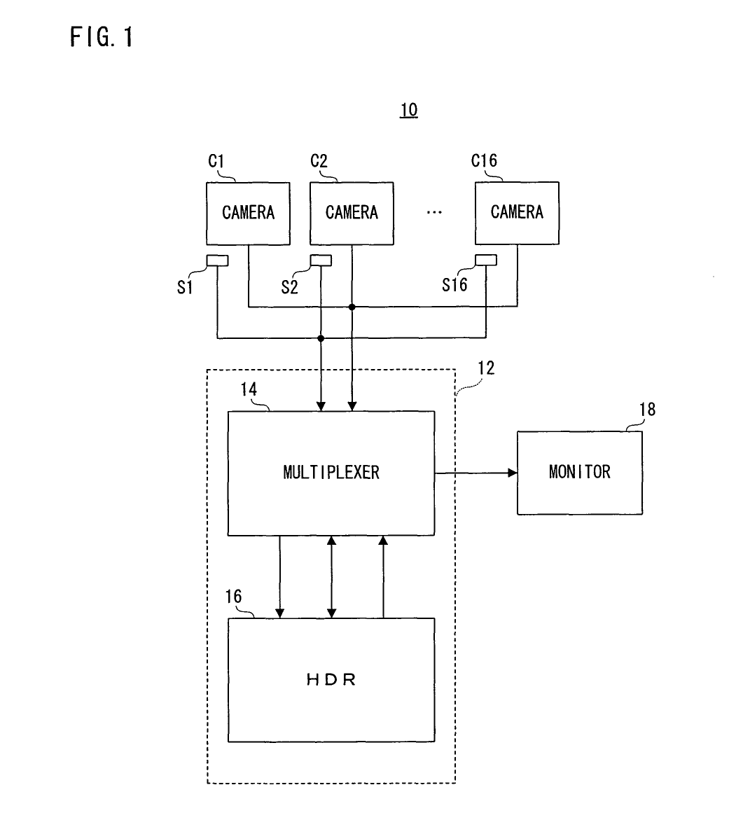

Referring to FIG. 1, a surveillance camera system 10 of this embodiment includes 16 of surveillance cameras C1 to C16 to which sensors S1 to S16 are respectively assigned, a video recorder 12 integrated with a multiplexer 14 and an HDR (Hard Disc Recorder) 16, and a monitor 22.

The surveillance cameras C1 to C16 are set at different positions from each other and output photographed image signals 1 to 16, respectively. Furthermore, the sensors S1 to S16 detect movements of object scenes photographed by the surveillance cameras C1 to C16, and generate alarms 1 to 16 when abnormal movements occur, respectively. The photographed image signals 1 to 16 and the alarms 1 to 16 are applied to the multiplexer 14.

A photographing rate of each of the surveillance cameras C1 to C16 is 60 fps (field per second), and the photographed signals 1 to 16 are output from the surveillance cameras C1 to C16 at 60 fields (60 screens) per second, respectively. It is noted that the surveillance cameras C1 to C16 operate independently of each other, and there is no guarantee that photographed images 1 to 16 are in phase with each other.

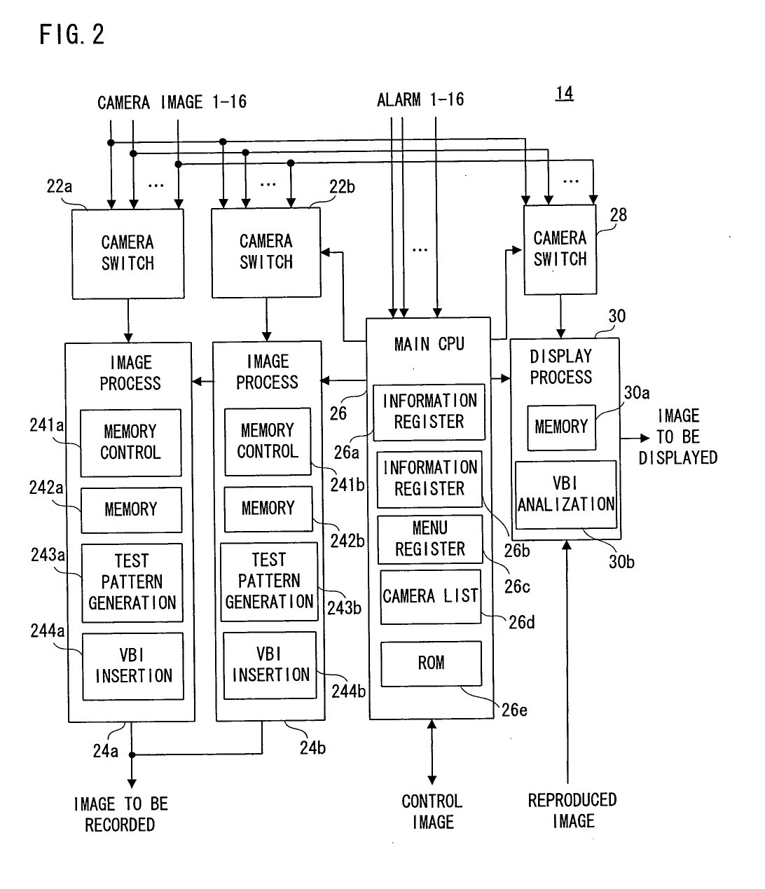

The multiplexer 14 is constructed as shown in FIG. 2. When a power is turned on, the main CPU 26 controls camera switch circuits 22a and 22b and image processing circuits 24a and 24b on the basis of setting of the image recording mode in a menu register 26c and an occurring state of the alarms 1 to 16.

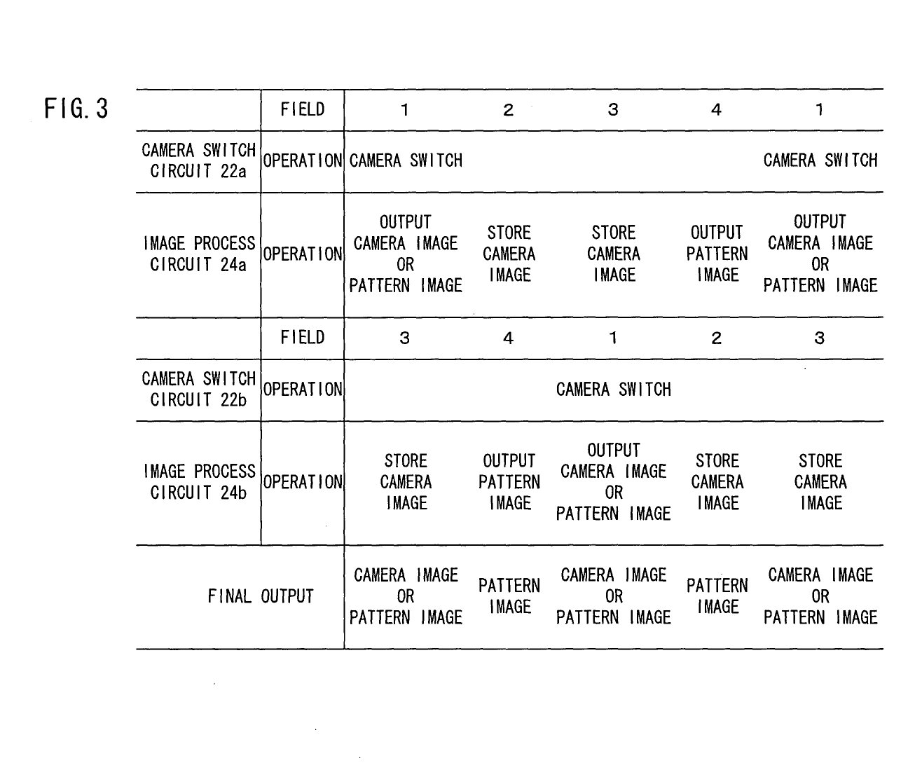

The camera switch circuit 22a and the image processing circuit 24a operate for 4 fields as a 1 cycle, and the camera switch circuit 22b and the image processing circuit 24b also operate for 4 fields as a 1 cycle. It is noted that, as shown in FIG. 3, there is a deviation of 2 fields between the operation of the camera switch circuit 22a and the image processing circuit 24a and the operation of the camera switch circuit 22b and the image processing circuit 24b.

Each of the camera switch circuits 22a and 22b switches a selecting of a surveillance camera at a first field forming 1 cycle and continues to select the same surveillance camera until a first field in a next 1 cycle. Although the surveillance cameras C1 to C16 are not in phase with each other, by continuing to select the same surveillance camera over 4 fields, it is possible to surely fetch 2 fields of photographed image signals output from the surveillance camera. Photographed image signals of 2 fields applied from the camera switch circuit 22a to the image processing circuit 24a are written to a memory 242a by a memory control circuit 241a. Furthermore, photographed image signals of 2 fields applied from the camera switch circuit 22b to the image processing circuit 24b are written to a memory 242b by a memory control circuit 241b.

Each of test patter signal generation circuits 243a and 243b absolutely outputs a test pattern image signal at a fourth field and outputs the test pattern image signal according to a setting of the image recording mode at the first field. Furthermore, each of the memory control circuits 241a and 241b reads a photographed image signal of an odd field from the memory 242 according to the setting of the image recording mode at the first field. That is, the test pattern image signal is absolutely output at the fourth field while the pattern image signal or the photographed image signal is output according to the setting of the recording mode at the first field.

As shown in FIG. 3, there is the deviation of 2 fields between the image processing circuits 24a and 24b. Thus, in all the first to fourth fields, either the test pattern image signal or the photographed image signal is output from the multiplexer 14. It is noted that a field at which the photographed image signal is output is defined as a “recording field”, and a field at which the test pattern image signal is output is defined as an “unnecessary field”.

The image recording mode includes a pre-alarm recording mode, a post-alarm recording mode and a normal recording mode. The pre-alarm recording mode and the normal recording mode are recording modes which are validated when no alarms 1 to 16 occur, and the post-alarm recording mode is the recording mode which is validated when any one of the alarms 1 to 16 occurs.

Each of VBI insertion circuits 244a and 244b generates a VBI (Vertical Blanking Interval) signal provided with an ID bit, a recording bit, a pre-alarm bit and a post-alarm bit, and multiplexes the VBI signal on the photographed image signal output from the memories 241a or 241b and the test pattern image signal generated by the test pattern image signal generation circuit 243a or 243b.

Herein, the ID bit is a bit for identifying a kind of the image signal. The ID bit of the VBI signal multiplexed on the photographed image signal indicates an ID (any one of “1” to “16”) of a camera from which the photographed image signal has been output. On the contrary thereto, the ID bit of the VBI signal multiplexed on the test pattern image signal is made indefinite (=*).

The recording bit is a bit for identifying which field the image signal is of, the recording field or the unnecessary field, and “1” indicates the recording field and “0” indicates the unnecessary field. The recording bit of the VBI signal multiplexed on the photographed image signal is made “1”, and the recording bit of the VBI signal multiplexed on the test pattern image signal is made “0”.

The pre-alarm bit and the post-alarm bit are bits for identifying the recording mode of the image signal. The VBI signal multiplexed on the photographed image signal corresponding to the pre-alarm recording mode has “1” as the pre-alarm bit and “0” as the post-alarm bit. Furthermore, the VBI signal multiplexed on the photographed image signal corresponding to the post-alarm recording mode has “0” as the pre-alarm bit and “1” as the post-alarm bit. In addition, the VBI signal multiplexed on the photographed image signal corresponding to the normal recording mode has “0” as the pre-alarm bit and “0” as the post-alarm bit.

The test pattern image signal generated at a time no alarms 1 to 16 occur is multiplexed with the VBI signal in which both the pre-alarm bit and the post-alarm bit are indefinite (=*). On the other hand, the pattern image signal generated at a time any one of the alarms 1 to 16 occurs is multiplexed with the VBI signal having the pre-alarm bit of “0” and the post-alarm bit of “1”.

It is noted that the ID bit, the recording bit, the pre-alarm bit and the post-alarm bit described above are defined as “VBI information”.

Each of the pre-alarm recording mode and the normal recording mode is set to either an on state or an off state by a menu operation. As to the recording mode being turned on, the surveillance camera that outputs the photographed image signal to be recorded and the recording rate of the photographed image signal are set by the menu operation. On the other hand, the post-alarm recording mode is turned on at all times, and a maximum recording rate of the photographed image signal from the surveillance camera in which the alarm occurs is set by the menu operation.

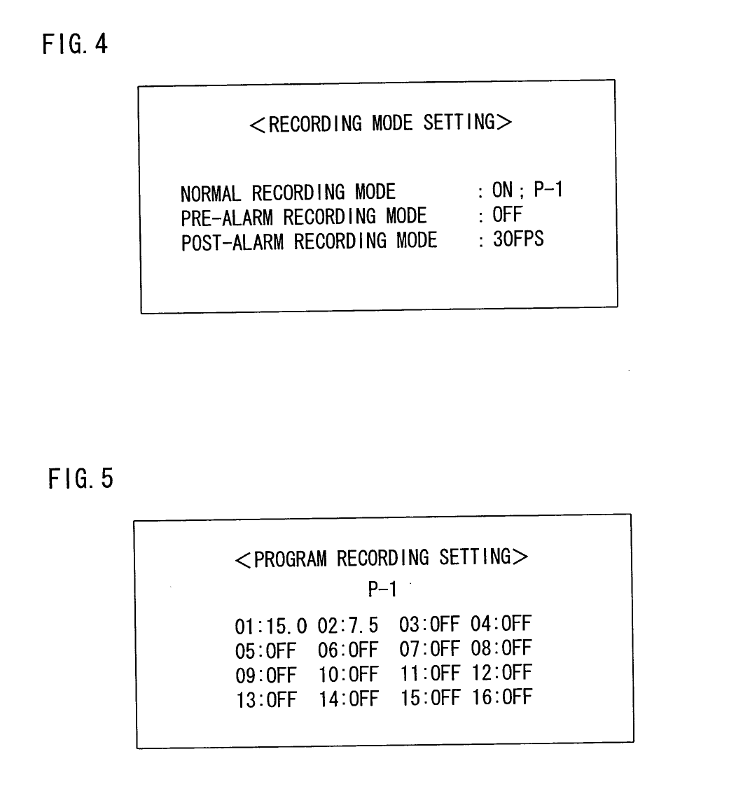

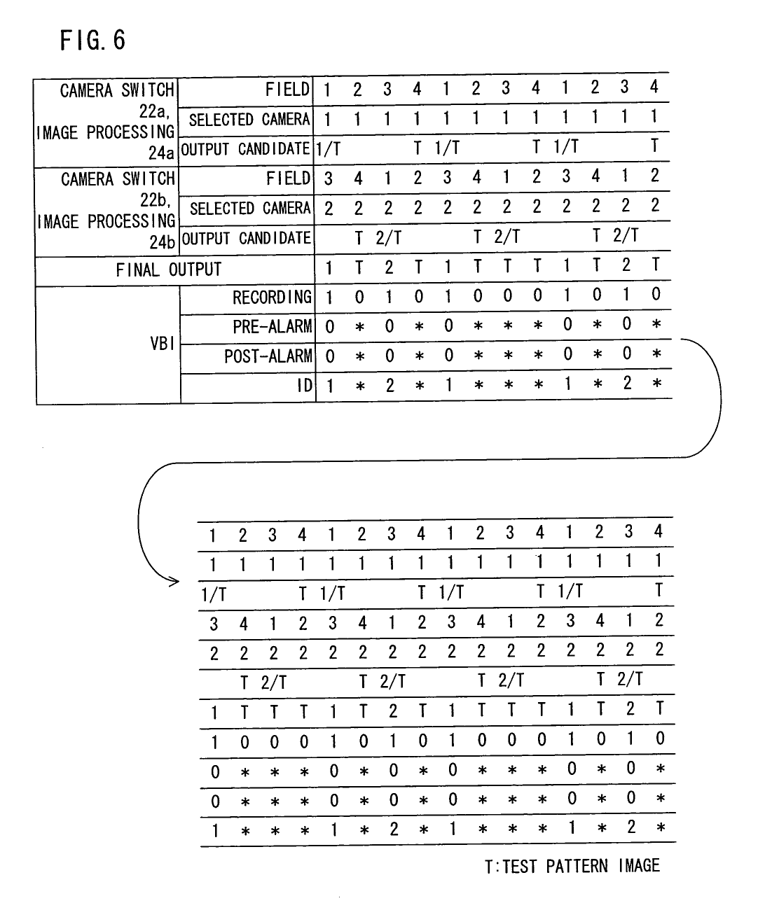

For example, in a case the normal recording mode is turned on and the pre-alarm recording mode is turned off as shown in FIG. 4, and a program P-1 shown in FIG. 5 is selected for the normal recording mode, a process is performed in the multiplexer 14 in such a manner as shown in FIG. 6. It is noted that according to FIG. 5, the surveillance cameras C1 and C2 are selected as the surveillance cameras for the normal recording. Furthermore, the recording rate of the surveillance camera C1 is set to 7.5 fps, and the recording rate of the surveillance camera C2 is set to 3.75 fps.

Referring to FIG. 6, the camera switch circuit 22a selects the surveillance camera C1 at all times, and the camera switch circuit 22b selects the surveillance camera C2 at all times. The image processing circuit 24a outputs a photographed image signal 1 or a test pattern image signal at the first field and outputs the test pattern image signal at the fourth field. Furthermore, the image processing circuit 24b outputs a photographed image signal 2 or the test pattern image signal at the first field and outputs the test pattern image signal at the fourth field.

The recording rate of the surveillance camera C1 is 7.5 fps, and the recording rate of the surveillance camera C2 is 3.75 fps. Therefore, the photographed image signal 1 is output from the image processing circuit 24a every 1 cycle, and the photographed image signal 2 is output from the image processing circuit 24b every 2 cycles.

Prior to outputting the photographed image signal 1 or the test pattern image signal from the image processing circuit 24a, the VBI insertion circuit 244a multiplexes the VBI signal having the recording bit of “1”, the pre-alarm bit of “0”, the post-alarm bit of “0” and the ID bit of “1” onto the photographed image signal 1, and multiplexes the VBI signal having the recording bit of “0”, the pre-alarm bit of “*”, the post-alarm bit of “*” and the ID bit of “*” onto the test pattern image signal. Furthermore, prior to outputting the photographed image signal 2 or the test pattern image signal from the image processing circuit 24b, the VBI insertion circuit 244b multiplexes the VBI signal having the recording bit of “1”, the pre-alarm bit of “0”, the post-alarm bit of “0” and the ID bit of “2” onto the photographed image signal 2, and multiplexes the VBI signal having the recording bit of “0”, the pre-alarm bit of“*”, the post-alarm bit of“*” and the ID bit of “*” onto the test pattern image signal.

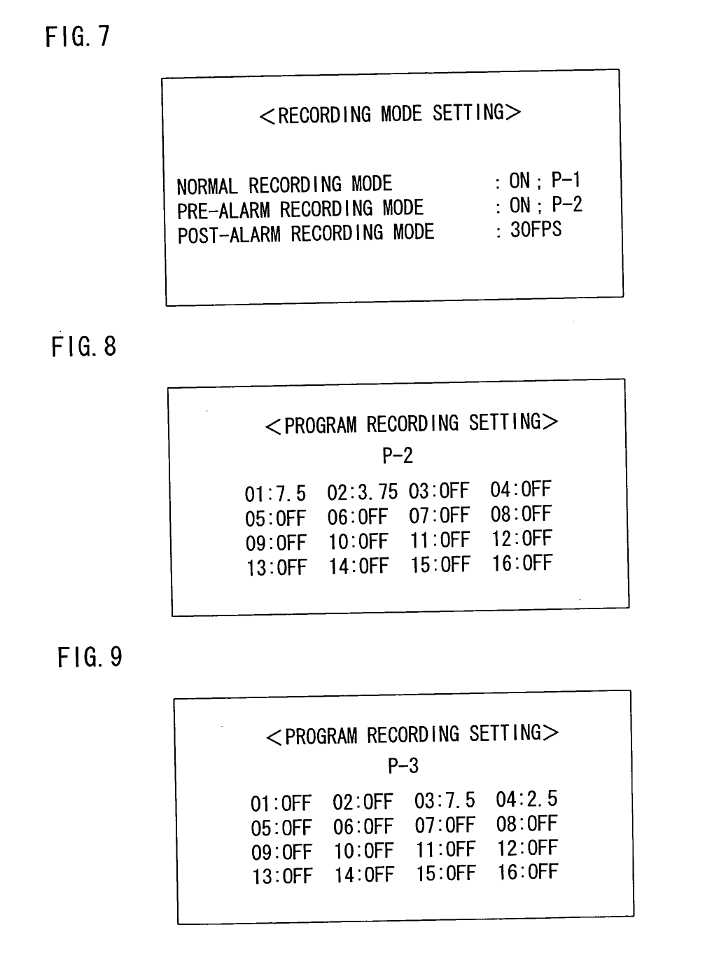

In addition, in a case the normal recording mode and the pre-alarm recording mode are turned on as shown in FIG. 7, a program P-2 shown in FIG. 7 is selected for the normal recording, and a program P-3 shown in FIG. 8 is selected for the pre-alarm recording, a process is executed in the multiplexer 14 in such a manner as shown in FIG. 9.

It is noted that according to FIG. 8, the surveillance cameras C1 and C2 are selected as the surveillance cameras for the normal recording, and the recording rates of the surveillance cameras C1 and C2 are set to 7.5 fps and 3.75 fps, respectively.

Furthermore, according to FIG. 9, the surveillance cameras C3 and C4 are selected as the surveillance cameras for the pre-alarm recording, and the recording rates of the surveillance cameras C3 and C4 are set to 7.5 fps and 2.5 fps, respectively.

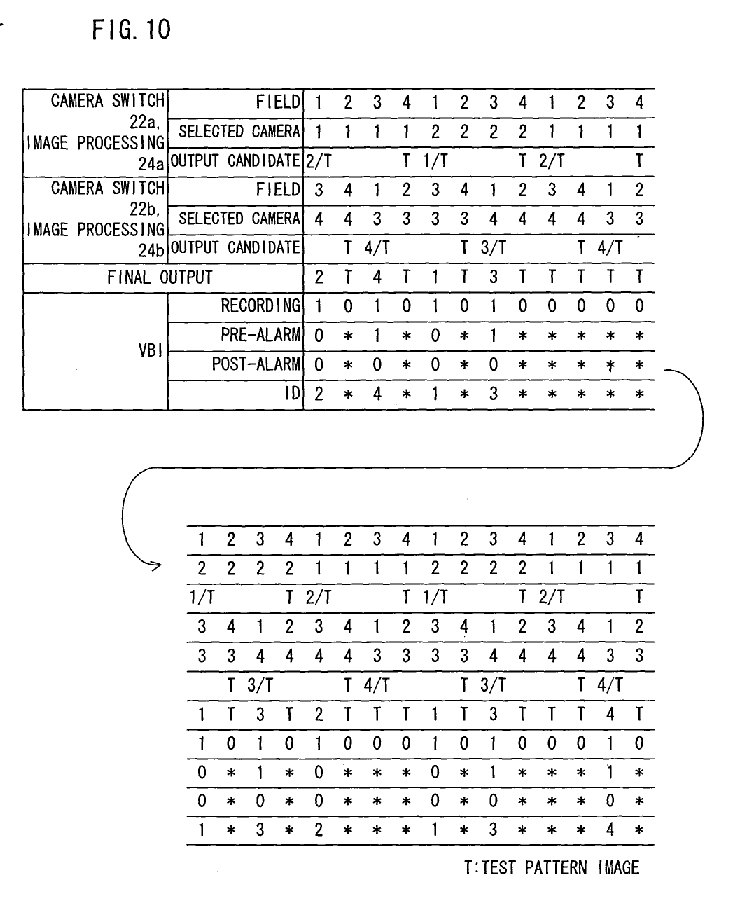

Referring to FIG. 10, the camera switch circuit 22a alternately selects the surveillance cameras C1 and C2 at every 4 fields, and the camera switch circuit 22b alternately selects the surveillance cameras C3 and C4 at every 4 fields. The image processing circuit 24a outputs the photographed image signal 2 or the test pattern image signal at the first field of the 1 cycle during which the surveillance camera C1 is selected, outputs the photographed image signal 1 or the test pattern image signal at the first field of the 1 cycle during which the surveillance camera C2 is selected, and outputs the test pattern image signal at the fourth field of each 1 cycle. Furthermore, the image processing circuit 24b outputs the photographed image signal 4 or the test pattern image signal at the first field of the 1 cycle during which the surveillance camera C3 is selected, outputs the photographed image signal 3 or the test pattern image signal in the first field of the 1 cycle during which the surveillance camera C4 is selected, and outputs the test pattern image signal at the fourth field of each 1 cycle.

The recording rates of the surveillance cameras C1 and C2 are 7.5 fps and 3.75 fps, respectively. Therefore, the photographed image signal 1 is output from the image processing circuit 24a every 2 cycles, and the photographed image signal 2 is output from the image processing circuit 24a every 4 cycles. Furthermore, the recording rates of the surveillance cameras C3 and C4 are 7.5 fps and 2.5 fps, respectively. Therefore, the photographed image signal 3 is output from the image processing circuit 24b every 2 cycles, and the photographed image signal 4 is output from the image processing circuit 24b every 6 cycles.

The photographed image signal 1 is multiplexed with the VBI signal having the recording bit of “1”, the pre-alarm bit of “0”, the post-alarm bit of “0” and the ID bit of “1” by the VBI insertion circuit 244a. The photographed image signal 2 is multiplexed with the VBI signal having the recording bit of “1”, the pre-alarm bit of “0”, the post-alarm bit of “0” and the ID bit of “2” by the VBI insertion circuit 244a. The photographed image signal 3 is multiplexed with the VBI signal having the recording bit of “1”, the pre-alarm bit of “0”, the post-alarm bit of “0” and the ID bit of “3” by the VBI insertion circuit 244b. The photographed image signal 4 is multiplexed with the VBI signal having the recording bit of “1”, the pre-alarm bit of “0”, the post-alarm bit of “0” and the ID bit of “4” by the VBI insertion circuit 244b. Furthermore, the test pattern image signal is multiplexed with the VBI signal having the recording bit of “0”, the pre-alarm bit of “*”, the post-alarm bit of “*” and the ID bit of “* ” by the VBI insertion circuit 244a or 244b.

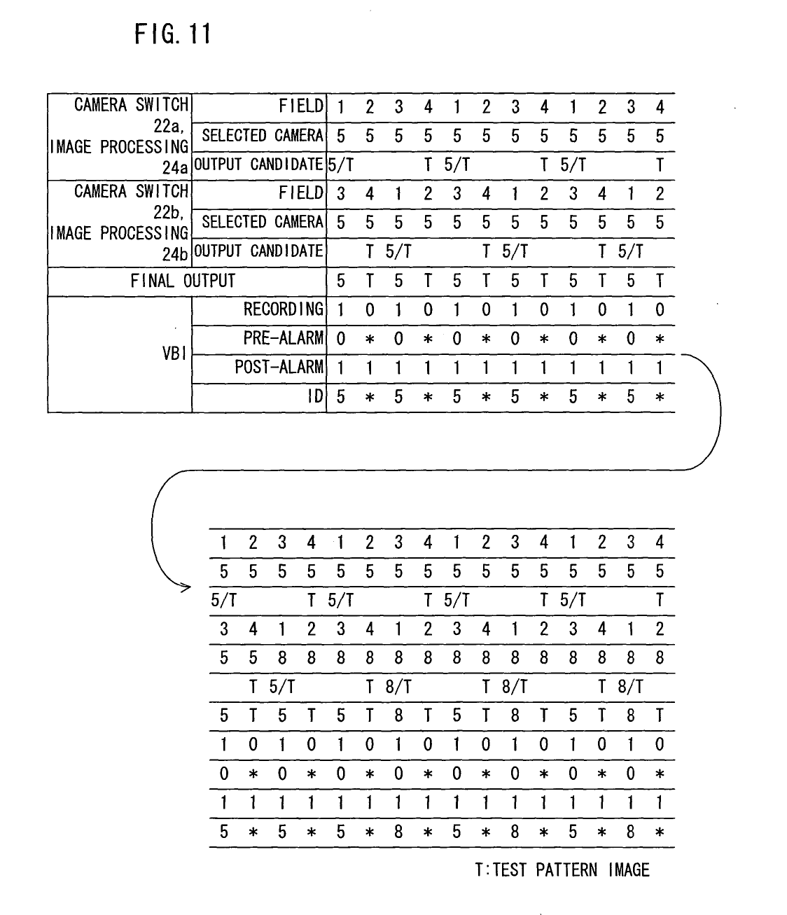

In a case the alarm 5 first occurs and the alarm 8 then occurs in a state the maximum recording rate in the alarm recording mode is set to 30 fps as shown in FIG. 3 or FIG. 6, the camera switch circuits 22a and 22b and the image processing circuits 24a and 24b operate as shown in FIG. 11.

At a time the alarm 5 has occurred, the surveillance camera C5 is selected by both the camera switch circuits 22a and 22b. The photographed image signal 5 output from the surveillance camera CS is input to the image processing circuit 24a through the camera switch circuit 22a and to the image processing circuit 24b through the camera switch circuit 22b. The image processing circuits 24a and 24b operate for 4 fields as 1 cycle as described above and outputs the photographed image signal 5 or the test pattern image signal at the first field and the test pattern image signal at the fourth field.

Since the set maximum recording rate is 30 fps, the photographed image signal 5 is output at the first field of any cycles. Accordingly, when only the alarm 5 occurs, the photographed image signal 5 of 30 fps can be obtained.

When the alarm 8 has occurred, the surveillance camera 8 is selected by the camera switch circuit 22b. Therefore, after the alarm 8 occurs, the photographed image signal 8 output from the surveillance camera CS is input to the image processing circuit 24b through the camera switch circuit 22b in place of the photographed image signal 5. The photographed image signal 8 is output from the image processing circuit 24b at the first field of each cycle.

Accordingly, at the same time that the alarm 8 occurs, an extraction rate of the photographed image signal 5 is decreased from 30 fps to 15 fps, and a remaining amount of 15 fps is assigned for the photographed image signal 8.

The VBI insertion circuit 244a multiplexes the VBI signal having the recording bit of “1”, the pre-alarm bit of “0”, the post-alarm bit of “1” and the ID bit of “5” onto the photographed image signal 5 and multiplexes the VBI signal having the recording bit of “0”, the pre-alarm bit of “*”, the post-alarm bit of “1”, and the ID bit of “*” onto the test pattern image signal in both cases only the alarm 5 occurs and the alarms 5 and 8 occur.

The VBI insertion circuit 244b multiplexes the VBI signal having the recording bit of “1”, the pre-alarm bit of “0”, the post-alarm bit of “1” and the ID bit of “5” onto the photographed image signal 5 and multiplexes the VBI signal having the recording bit of “0”, the pre-alarm bit of “*”, the post-alarm bit of “1”, and the ID bit of “*” onto the test pattern image signal when the alarm 5 occurs. The VBI insertion circuit 244b further multiplexes the VBI signal having the recording bit of “1”, the pre-alarm bit of “0”, the post-alarm bit of “1” and the ID bit of “8” onto the photographed image signal 8 and multiplexes the VBI signal having the recording bit of “0”, the pre-alarm bit of “*”, the post-alarm bit of “1” and the ID bit of “*” onto the test pattern image signal when the alarm 8 occurs.

The photographed image signals 1 to 16 output from the surveillance cameras C1 to C16 are also applied to the camera switch circuit 28. A desired surveillance camera is selected in the camera switch circuit 28, and a photographed image signal of the desired surveillance camera is output to the monitor 22 shown in FIG. 1 through the camera switch circuit 28 and the a memory 30a within a display processing circuit 30. Consequently, a live image photographed by the desired surveillance camera is displayed on the monitor screen.

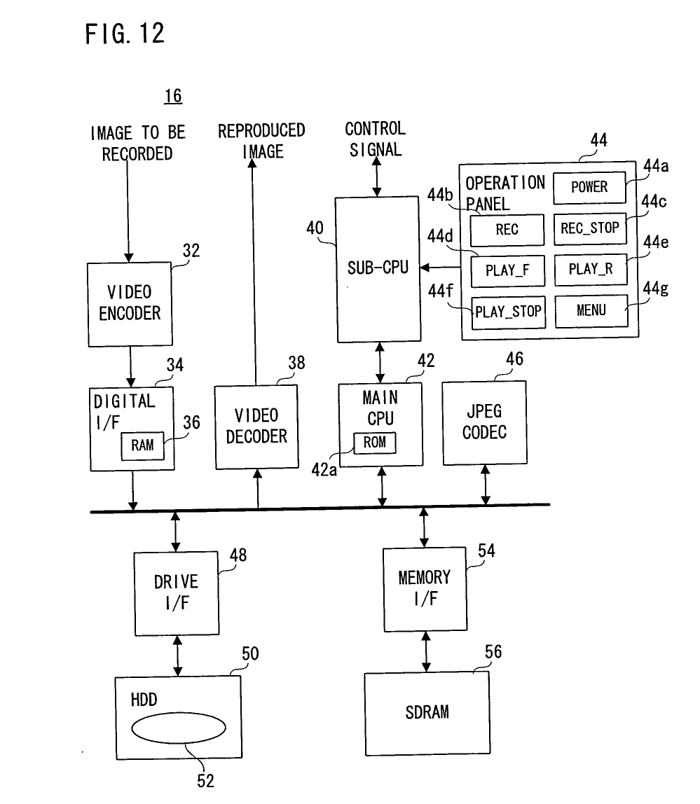

The photographed image signal or the test pattern image signal output from each of the camera image processing circuits 24a and 24b is applied to the HDR 16 shown in FIG. 1. The HDR 16 is constructed as shown in FIG. 12, and the photographed image signal or the test pattern signal is specifically applied to a video encoder 32.

The video encoder 32 converts the applied photographed image signal or the test pattern signal into photographed image data or test pattern image data being a digital signal. A digital I/F circuit 34 stores VBI data included in the image data having been converted by the video encoder 32 in a RAM 36 and applies the image data (including the VBI data) to a memory I/F circuit 54.

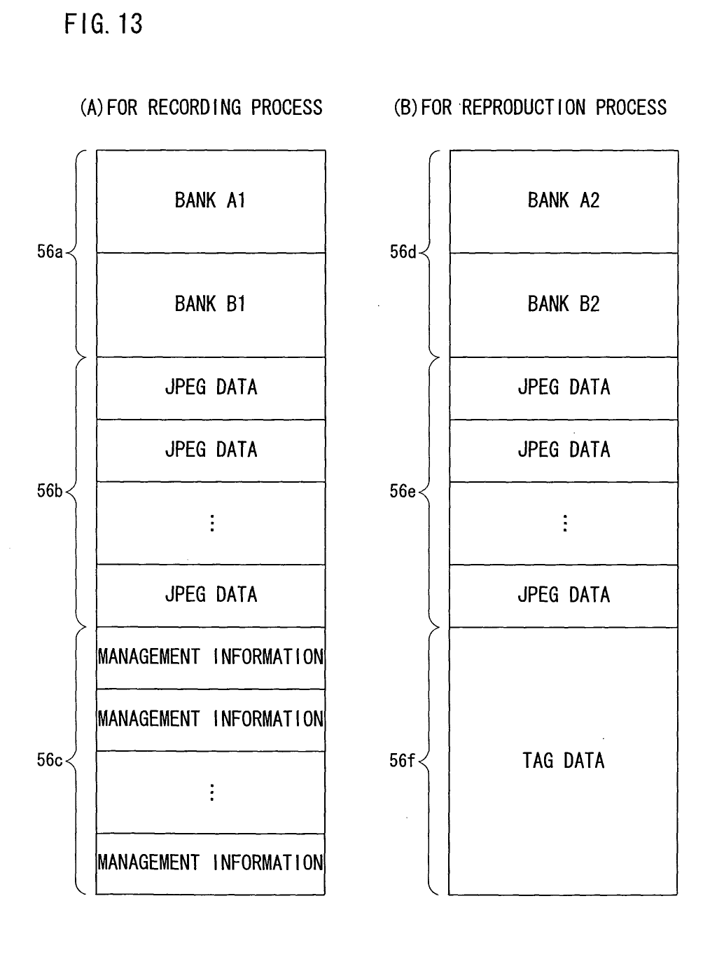

Referring to FIG. 13 (A), an SDRAM 56 has an input image area 56a, a compressed mage area 56b and a management information area 56c as areas for a recording process, and the input image area 56a is formed by banks A1 and B1. The image data of each field output from the digital I/F circuit 34 is alternately written to the banks A1 and B1 by the memory I/F circuit 54.

A main CPU 42 analyzes the VBI data stored in the RAM 36 and performs a recording process according to an analysis result on the corresponding image data stored in the input image area 56a. More specifically, if the recording bit included in the VBI data is “0”, the main CPU 42 considers the corresponding image data as the test pattern image data and invalidates the image data. On the other hand, if the recording bit included in the VBI data is “1”, each of states of the pre-alarm bit and the post-alarm bit is determined. Herein, if the pre-alarm bit and the post-alarm bit are “1” and “0”, respectively, a pre-alarm recording process is performed, and if the pre-alarm bit and the post-alarm bit are “0” and “1”, respectively, a post-alarm recording process is performed. Furthermore, if a normal recording operation is performed and both the pre-alarm bit and the post-alarm bit are “0”, a normal recording process is performed.

In any of the recording processes, the photographed image data stored in the input image area 56a is applied to a JPEG codec 46 via the memory I/F circuit 54 and is subjected to a JPEG compression. JPEG data generated by the JPEG compression is stored in the compressed image area 56b via the memory I/F circuit 54. Furthermore, management information for managing the JPEG data is created by the main CPU 42 and stored in the management information area 56c. The JPEG data and the management information stored in the SDRAM 56 are applied to an HDD (Hard Disk Drive) 50 via the memory I/F circuit 54 and a drive I/F circuit 48 so as to be recorded in a hard disk 52 by the HDD 50.

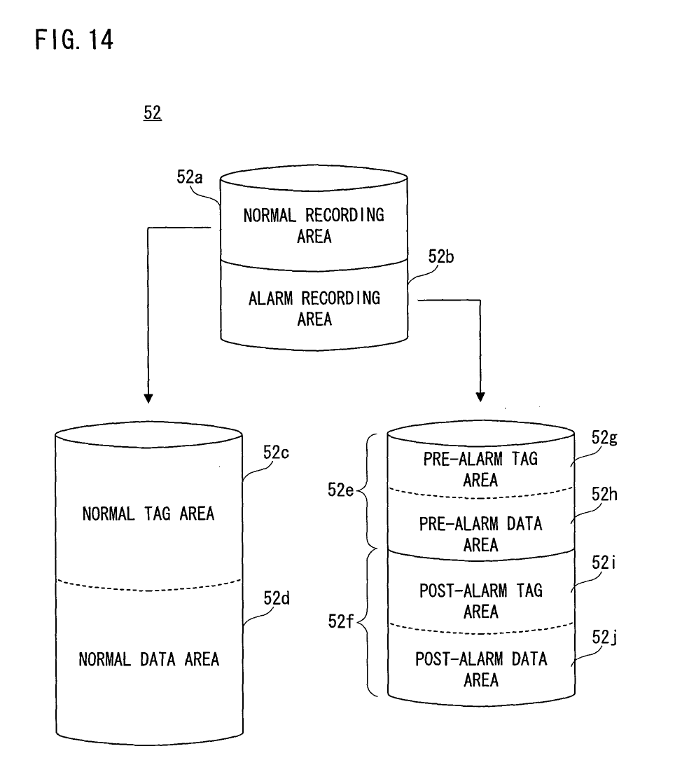

As shown in FIG. 14, the hard disk 52 is divided into a normal recording area 52a and an alarm recording area 52b. Furthermore, the normal recording area 52a is divided into a normal tag area 52c and a normal data area 52d, and the alarm recording area 52b is divided into a pre-alarm area 52e and a post-alarm area 52f. Furthermore, the pre-alarm area 52e is divided into a pre-alarm tag area 52g and a pre-alarm data area 52h, and the post-alarm area 52f is divided into a post-alarm tag area 52i and a post-alarm data area 52j.

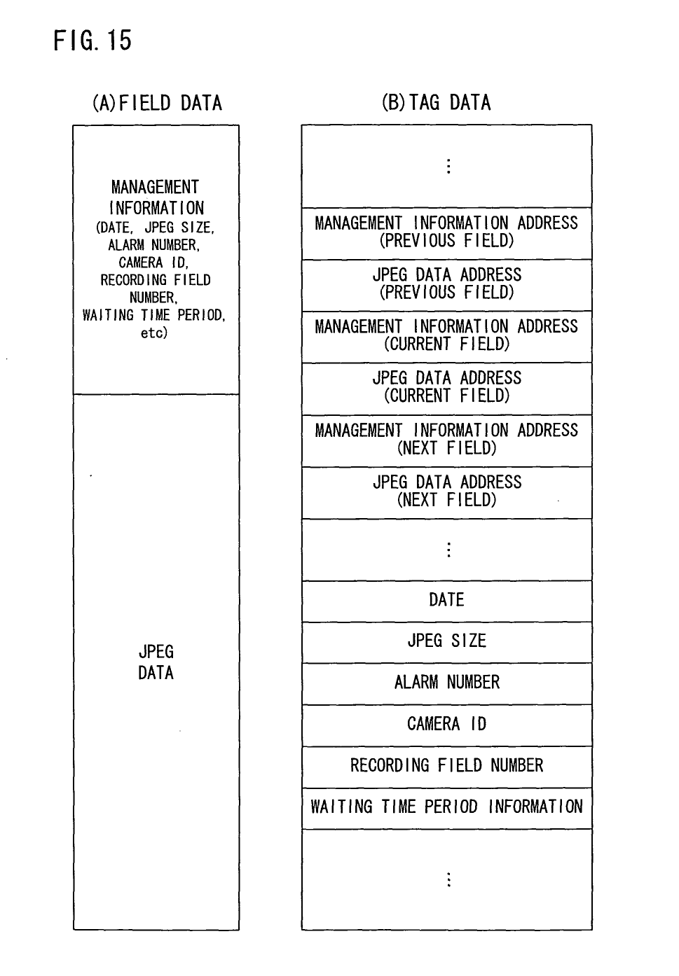

The management information and the JPEG data which are obtained by the normal recording process is recorded in the normal recording area 52d, the management information and the JPEG data which are obtained by the pre-alarm recording process is recorded in the pre-alarm data area 52h, and the management information and the JPEG data which are obtained by the post-alarm recording process is recorded in the post-alarm data area 52j. At this time, the management information and the JPEG data related with each other is connected as shown in FIG. 15 (A). It is noted that the management information and the JPEG data related with each other is defined as “filed data”.

The management information includes a photographing date, a JPEG size, an alarm number, a camera ID, a recording field number, a waiting time period information and etc. The management information is represented by 64 bytes and is not varied in size depending upon the field.

The photographing date is the same as a fetching date of photographed image data and also includes information such as “minute” and “second”. The JPEG size is a size of relating JPEG data. The alarm number is an identification number of an alarm and is required when photographed image data of a desired surveillance camera is searched from among the photographed image data recorded on the post-alarm data area 52j. For example, in a case the post-alarm recording is executed due to occurrence of the alarm 5, the alarm number becomes “5”. In a case the pre-alarm recording or the normal recording is executed, the alarm number becomes indefinite (=*).

The camera ID is an identifier of the surveillance camera by which the relating JPEG data is photographed. The recording field number is a number which is assigned to each of the JPEG data in a generating order. The waiting time period information is a difference between a generating field of previous JPEG data and a generating field of current JPEG data, and is required for controlling a reproduction timing of each of the JPEG data.

The main CPU 42, after completion of recording 1 field of the management information and 1 field of the JPEG data, creates address information with respect to successive 3 fields of the management information and successive 3 fields of the JPEG data. That is, the main CPU 42 creates a head address of the management information in a previous field, a head address of the JPEG data in the previous field, a head address of the management information in a current field, a head address of the JPEG data in the current field, a head address of the management information in a next field and a head address of the JPEG data in the next field. Since the management information is 64 bytes at all times, the head address of the management information in the next field and the head address of the JPEG data in the next field are calculated on the basis of the head address and the JPEG size of the JPEG data in the current field.

When the address information of the successive 3 fields is thus generated, the main CPU 42 creates tag data including such the address information and the management information of the current field as shown in FIG. 15 (B) and records the created tag data in the hard disk 52 through the HDD 50. Referring to FIG. 14, the tag data obtained by the normal recording process is recorded in the normal tag area 52c, the tag data obtained by the pre-alarm recording process is recorded in the pre-alarm tag area 52g, and the tag data obtained by the post alarm recording process is recorded in the post-alarm tag area 52i.

When a reproduction operation is performed, the main CPU 42 reads by one operation tag data relating to an image to be reproduced from the hard disk 52 via the drive I/F circuit 48 and the HDD 50 and writes the read tag data to the SDRAM 56 via the memory VF circuit 54. When reproducing the JPEG data recorded by the normal recording mode, the tag data recorded in the normal tag area 52c is transferred to the SDRAM 56, when reproducing the JPEG data recorded by the pre-alarm recording mode, the tag data recorded in the pre-alarm tag area 52g is transferred to the SDRAM 56, and when reproducing the JPEG data recorded by the post-alarm recording mode, the tag data recorded in the post-alarm tag area 52i is transferred to the SDRAM 56.

Referring to FIG. 13 (B), the SDRAM 56 is formed with an output image area 56d, compressed image area 56e, tag data area 56f for reproducing. The tag data is written to the tag data area 56f.

Furthermore, the main CPU 42 specifies the JPEG data of each filed on the basis of the address information included in the transferred tag data and controls a reproduction timing of the JPEG data of each field on the basis of the waiting time period information included in the transferred tag data. The JPEG data reproduced from the hard disk 52 at a desired timing is temporarily stored in the compressed image area 56eof the SDRAM 56 and then expanded by the JPEG codec 46. Photographed image data obtained by the JPEG expansion is applied to the video decoder 38 via the output image area 56d of the SDRAM 56 so as to be converted into a photographed image signal being an analog signal. The converted photographed image signal is output to the multiplexer 14.

Referring to FIG. 2, the photographed image signal output from the HDR 16 is applied to the display processing circuit 30. A VBI analysis circuit 30b extracts a VBI signal from the applied photographed image signal and analyzes the ID bit of the extracted VBI signal. Which address of the memory 30a the photographed image signal is written to is controlled by the analysis result of the ID bit. The photographed image signal stored in the memory 30a is then output to the monitor 22, and whereby, a reproduced image is displayed on the monitor screen.

Referring to FIG. 12, an instruction of an operator is accepted by an operation panel 44. More specifically, an instruction of power ON/OFF is accepted by a power button 44a, an instruction of starting the normal recording is accepted by a recording button 44b, and an instruction of stopping the normal recording is accepted by a recording stop button 44c. Furthermore, an instruction of staring reproduction at a normal speed in a forward direction is accepted by a reproduction button 44d, an instruction of starting reproduction at a normal speed in a reverse direction is accepted by a reverse reproduction button 44e, and an instruction of stopping the reproduction is accepted by a reproduction stop button 44f. Furthermore, change of setting of the recording mode shown in FIG. 4 or FIG. 7, or change of setting of the recording program shown in FIG. 5, FIG. 8 or FIG. 9 is accepted by a menu button 44g.

It is noted that the change of the setting of the recording program shown in FIG. 5, FIG. 8 or FIG. 9, i.e., addition of a surveillance camera to be selected and/or change of the recording rate are acceptable as long a process is not broken out. That is, as the surveillance camera to be selected is few in number, the recording rate can be set to higher numeral, and as the surveillance camera to be selected increases in number, the settable recording rate is decreased.

A sub-CPU 40, when an ON operation is performed by the power button 44a, turns the power of the HDD 16 on and applies power-on information to a main CPU 26 of the multiplexer 14. Furthermore, when the recording button 44b, the recording stop button 44c, the reproduction button 44d, the reverse reproduction button 44e or the reproduction stop button 44f is operated, the sub-CPU 40 applies corresponding button operating information to the main CPU 42. In addition, when a setting change operation is performed by the menu button 44g, the sub-CPU 40 applies a setting change request to the main CPU 26 and applies information relating to an ON/OFF state of the pre-alarm recording mode.

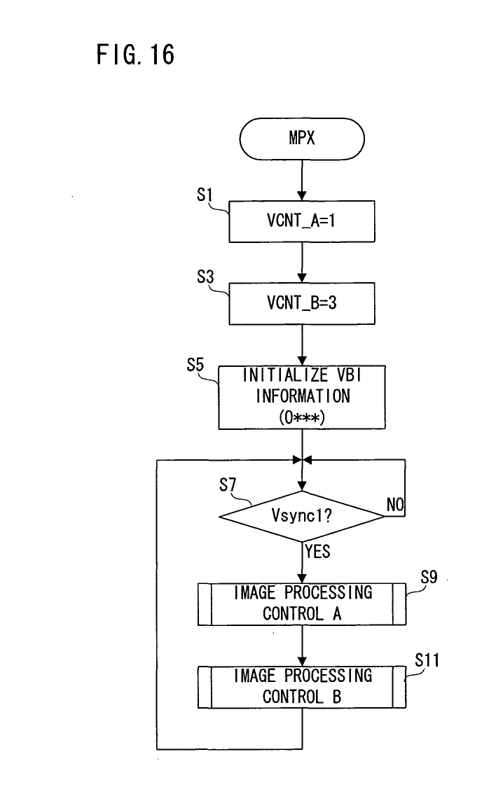

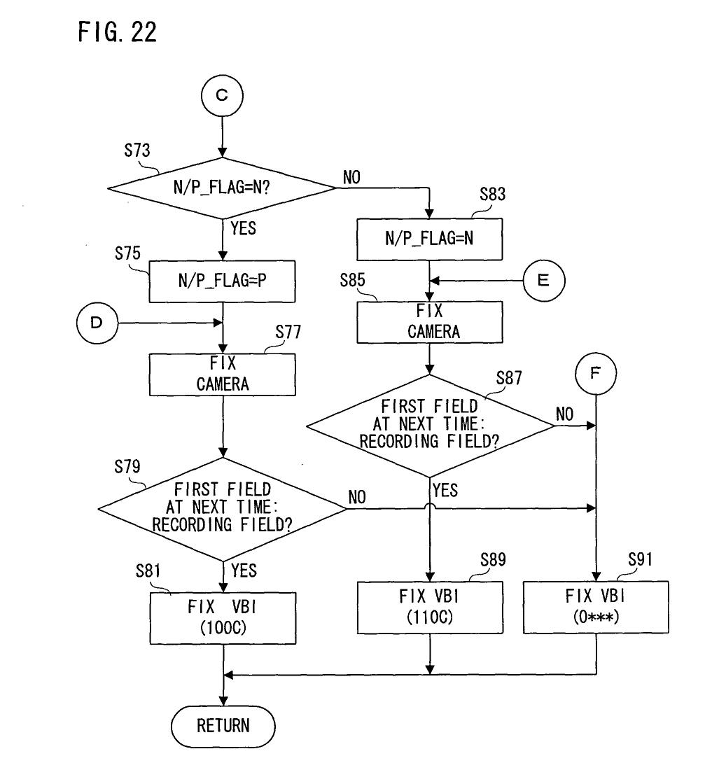

The main CPU 26 of the multiplexer 14 operates according to flowcharts shown in FIG. 16 to FIG. 23. It is noted that a control program corresponding to the flowcharts is stored in a ROM 26e.

First, a variable VCNT_A is set to “1” in a step S1, and a variable VCNT_B is set to “3” in a step S3. This causes deviation of two fields between the variable VCNT_A and the variable VCNT_B. The VBI information is initialized in a step S5. The recording bit indicates “0”, and each of the pre-alarm bit, the post-alarm bit, and the ID bit indicates “* ”. It is determined whether or not a vertical synchronization signal Vsync 1 is generated in a step S7, and if “YES” is determined, an image processing control A is executed in a step S9, and an image processing control B is executed in a step S11. After completion of the process in the step S11, the process returns to the step S7. The vertical synchronization signal Vsync1 is a signal which is generated every 1/60 seconds within a multiplexer 14, and the processes in the steps S9 and S11 are executed every 1/60 seconds.

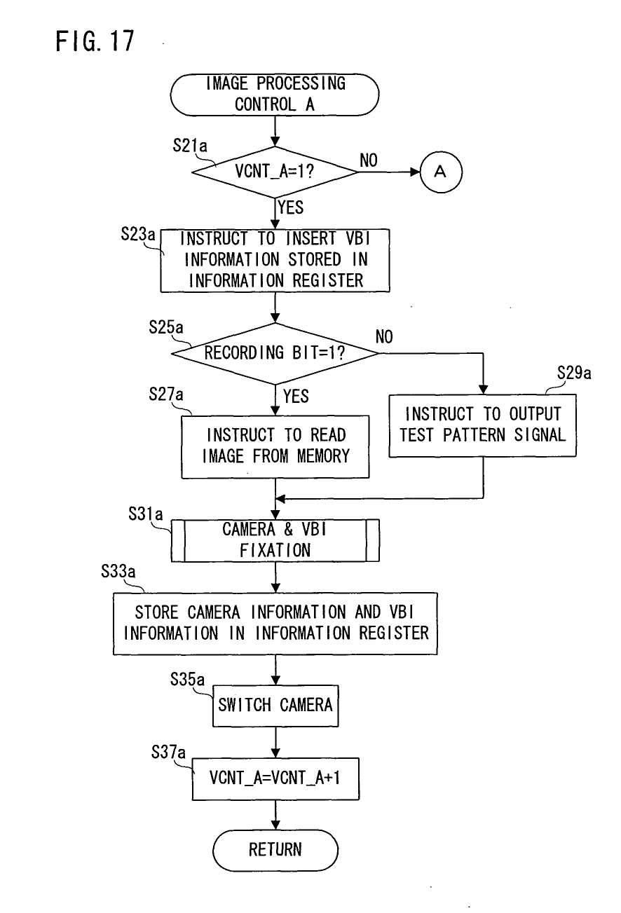

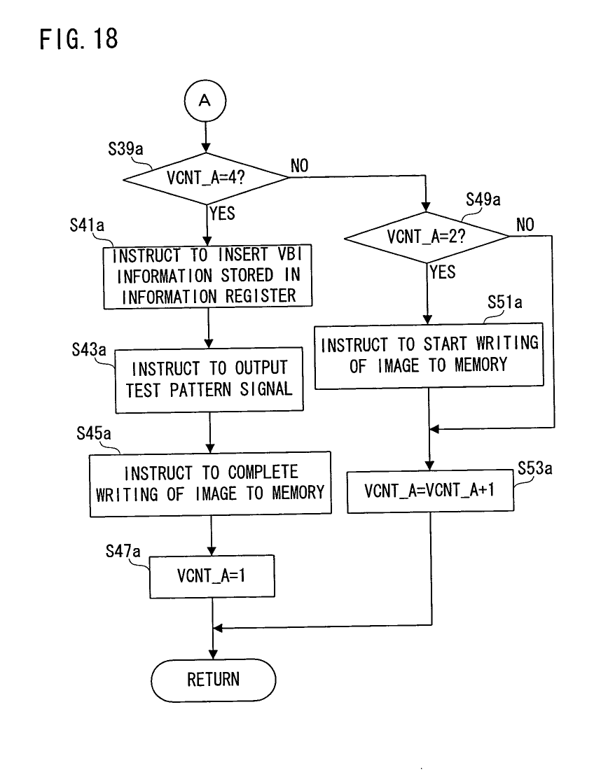

The image processing control A in the step S9 complies with a subroutine shown in FIG. 17 to FIG. 18. First, the variable VCNT_A is determined in steps S21a, S39a, and S 47a. If VCNT_A=1, “YES” is determined in the step S21a, and a process in a step S23a and the subsequent is executed.

The VBI information insertion circuit 244a is instructed to insert a VBI signal including the VBI information stored in the information register 26a in the step S23a, and the recording bit included in the VBI information is identified in a following step S25a. If the recording bit=1, the process proceeds to a step S27a so as to instruct the memory control circuit 241a to read a photographed image signal in the odd field from the memory 242a. On the other hand, if the recording bit=0, the process proceeds to a step S29a so as to instruct the test pattern image signal generation circuit 243a to output a test pattern image signal. Therefore, the photographed image signal or the test pattern image signal of 1 field on which the VBI signal including the VBI information of the information register 26a is multiplexed is output from the image processing circuit 24a.

A camera & VBI fixation process is executed in a step S31a, and camera information and VBI information determined by the process in the step S31a are stored in the information register 26a in a step S33a. In a step S35a, a setting of the camera switch circuit 22a is switched according to the camera information determined by the process in the step S31a. Therefore, the photographed image signal from a surveillance camera indicated by the camera information is input to the image processing circuit 24a through the camera switch circuit 22a. After completion of the process in the step S35a, the variable VCNT_A is incremented in a step S37a and then, the process is restored to an upper hierarchical routine.

If the variable VCNT is “2”, “YES” is determined in a step S49a, and the memory control circuit 241a is instructed to start to write the photographed image signal to the memory 241a in a step S51a. The memory control circuit 241a starts to write the photographed image signal output from the camera switch circuit 22a to the memory 242a. After completion of the process in the step S51a, the variable VCNT_A is incremented in a step S53a, and then, the process is restored to the upper hierarchical routine.

If the variable VCNT is “3”, “NO” is determined in the step S49a. At this time, the variable VCNT_A is incremented in the step S53a, and then, the process is restored to the upper hierarchical routine.

If the variable VCNT is “4”, “YES” is determined in a step S39a, the VBI insertion circuit 244a is instructed to insert the VBI information stored in the information register 26a in a step S41a, and the test pattern signal generation circuit 243a is instructed to output the test pattern image signal in a step S43a. The test pattern image signal onto which the VBI information of the information register 26a is multiplexed is output from the image processing circuit 24a. The memory control circuit 241a is instructed to stop writing the photographed image signal to the memory 242a in a step S45a. Therefore, the memory control circuit 241a stops writing the photographed image signal fetched through the camera switch circuit 22a. After completion of the process in the step S45a, the variable VCNT_A is set to “1” in a step S47a, and then, the process is restored to the upper hierarchical routine.

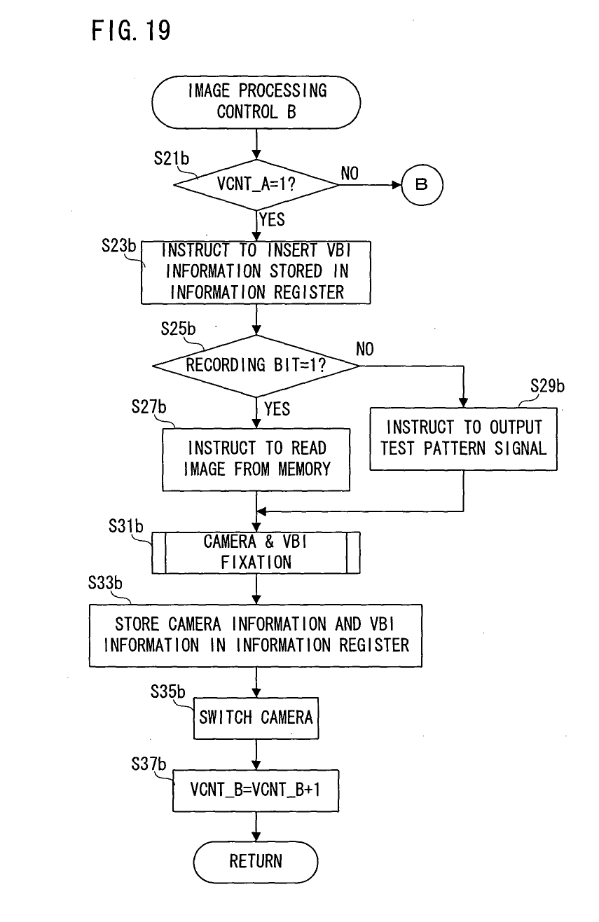

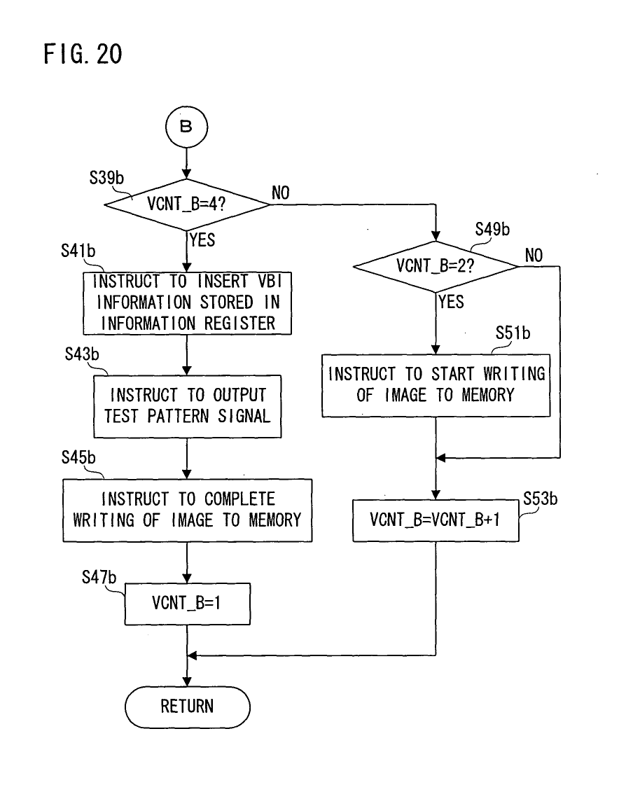

Although the image processing control B in the step S11 complies with a subroutine shown in FIG. 19 and FIG. 20, the subroutine is the same as the subroutine shown in FIG. 17 and FIG. 18 except that the variable VCNT_B is determined in the step S21b, S39b and S49b, a storing destination of the VBI information and the camera information is the information register 26b, and the object to be controlled is the camera switch circuit 22b and the image processing circuit 24b, and therefore, a duplicate description is omitted.

The camera & VBI fixation process in the step S31a shown in FIG. 17 or a step S31b shown in FIG. 19 complies with a subroutine shown in FIG. 20. That is, the camera & VBI fixation process is executed according to a common subroutine.

First, it is determined whether or not a setting change request is input from the HDR 16 in a step S61. Unless the setting change request is input, the process directly proceeds to a step S65 while if the setting change request is input, a setting of the menu register 26c is changed in a step S63, and then, the process proceeds to a step S65. In the step S65, it is determined whether the current state is in an alarm occurring state or not in the step S65, and if a non-alarm occurring state, a setting of the recording mode is identified in each of the steps S67 to S71.

When both the normal recording mode and the pre-alarm recording mode are in the on states, “YES” is determined in the step S67, and then, the process proceeds to a step S73. When the normal recording mode is in the on state and the pre-alarm recording mode is in the off state, “YES” is determined in the step S69, and then, the process proceeds to the step S77. When the normal recording mode is in the off state and the pre-alarm recording mode is in the on state, “YES” is determined in a step S71 and then, the process proceeds to a step S85. When both the normal recording mode and the pre-alarm recording mode are in the off states, “NO” is determined in the step S71 and then, the process proceeds to a step S91.

A state of a variable N/P_FLAG is determined in a step S73, and if N/P_FLAG=N, the process proceeds to a step S75 while if N/P_FLAG=P, the process proceeds to a step S83. The variable N/P_FLAG is a variable for determining which is to be performed, the normal recording or the pre-alarm recording, and “N” indicates the normal recording while “P” indicates the pre-alarm recording.

In the step S75, the variable N/P_FLAG is changed from “N” to “P” so as to obtain a determination result of “NO” in the step S73 at the next time. In a following step S77, a camera fixation is performed. More specifically, a surveillance camera to be validated in a next cycle is fixed out of the surveillance cameras selected in the normal recording mode.

In a step S79, it is determined whether the first field in the next cycle is the recording field or the unnecessary field on the basis of a recording rate of the determined surveillance camera. If the recording field is determined, the VBI information is fixed in a step S81. The fixed VBI information includes “1”, “0” and “0” as the recording bit, the pre-alarm bit, and the post-alarm bit, respectively, and includes an identifier of the surveillance camera fixed in the step S77 as the ID bit. On the other hand, if the unnecessary field is determined in the step S79, the VBI information is fixed in a step S91. The fixed VBI information has the recording bit indicative of “0”, the pre-alarm bit, the pos-alarm bit and the ID bit indicative of “*”. After completion of the process in the step S81 or the step S91, the process is restored to the upper hierarchical routine.

In a step S83, the variable N/P_FLAG is set to “N” so as to obtain a determination result of “YES” in the step S73 next time. In a step S85, the camera fixation is performed in the same manner as the step S77. Therefore, a surveillance camera to be validated in the next cycle is fixed out of the surveillance cameras selected in the pre-alarm recording mode.

It is determined whether the first field in the next cycle is the recording field or the unnecessary field on the basis of a recording rate of the determined surveillance camera in a step S87. If the recording field is determined, the VBI information is fixed in a step S89. The fixed VBI information includes “1”, “1” and “0” as the recording bit, the pre-alarm bit and the post-alarm bit, respectively, and includes the identifier of the surveillance camera fixed in the step S85 as the ID bit. If the unnecessary field is determined in the step S87, the VBI information is fixed in the step S91. After completion of the process in the step S89 or the step S91, the process is restored to the upper hierarchical routine.

There is a deviation of two fields between the variables VCNT_A and the VCNT_B, and the camera & VBI fixation process is executed at a time of the VCNT_A=1 and at a time of the VCNT_B=1. Therefore, a determination of the variable N/P_FLAG in the step S73 is performed every 2 fields, and the renewal of the variable N/P_FLAG in the step S75 or S83 is also performed every 2 fields. Thus, when the recording mode setting shown in FIG. 7 to FIG. 9 is performed, the surveillance camera is switched every 2 fields as shown in FIG. 10.

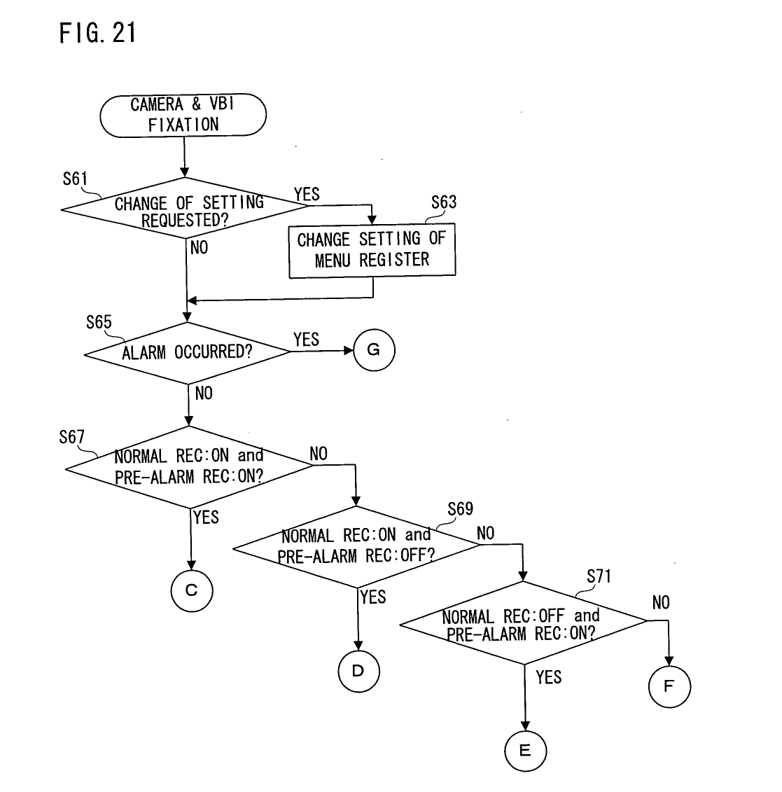

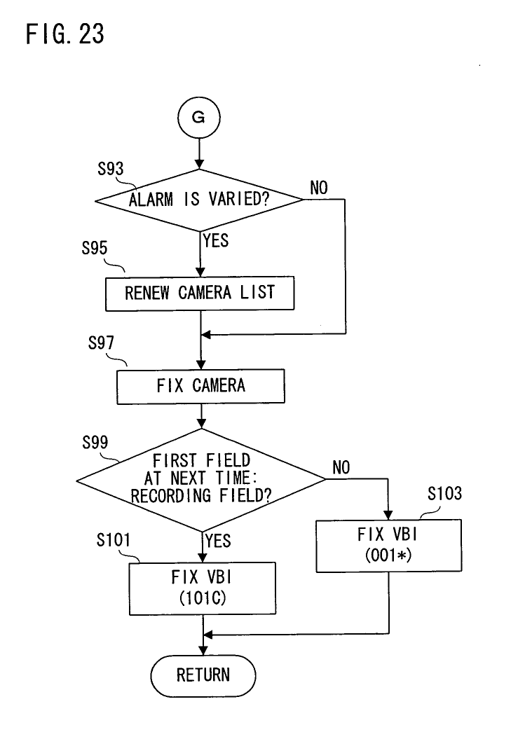

When the alarm occurring state is determined in the step S65 shown in FIG. 21, the process proceeds to a step S93 shown in FIG. 23 so as to determine that variation (increase or decrease) occurs to the alarm generated at this time. If there is no variation herein, the process directly proceeds to a step S97 while if the variation occurs, the camera list 26d is renewed in a step S95, and then, the process proceeds to the step S97. More specifically, in the step S95, when a new alarm occurs, the surveillance camera corresponding to the alarm is added to the camera list 26d, and when the alarm is stopped, the surveillance camera corresponding to the stopped alarm is erased from the camera list 26d. Accordingly, the surveillance camera to which the alarm occurs at this time is registered in the camera list 26d. In the step S97, the surveillance camera to be validated in the next cycle is fixed from among the surveillance cameras registered in the camera list 26d.

It is determined whether the first field in the next cycle is the recording field or the unnecessary field on the basis of a recording rate of the fixed surveillance camera in a step S99. If the recording field is determined, the VBI information is fixed in a step S101. The fixed VBI information includes “1”, “0” and “1” as the recording bit, the pre-alarm bit and the post-alarm bit, respectively, and includes an identifier of the surveillance camera fixed in the step S97 as the ID bit. If the unnecessary field is determined in the step S99, the VBI information is fixed in a step S103. The fixed VBI information includes “0”, “0”, “1”, and “*” as the recording bit, the pre-alarm bit, the post-alarm bit and the ID bit, respectively. After completion of the process in the step S101 or the step S103, the process is restored to the upper hierarchical routine.

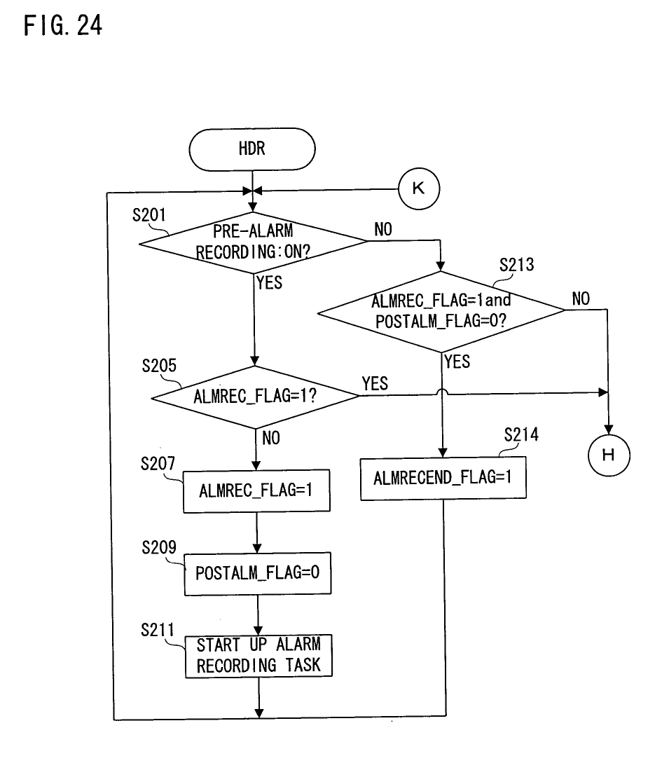

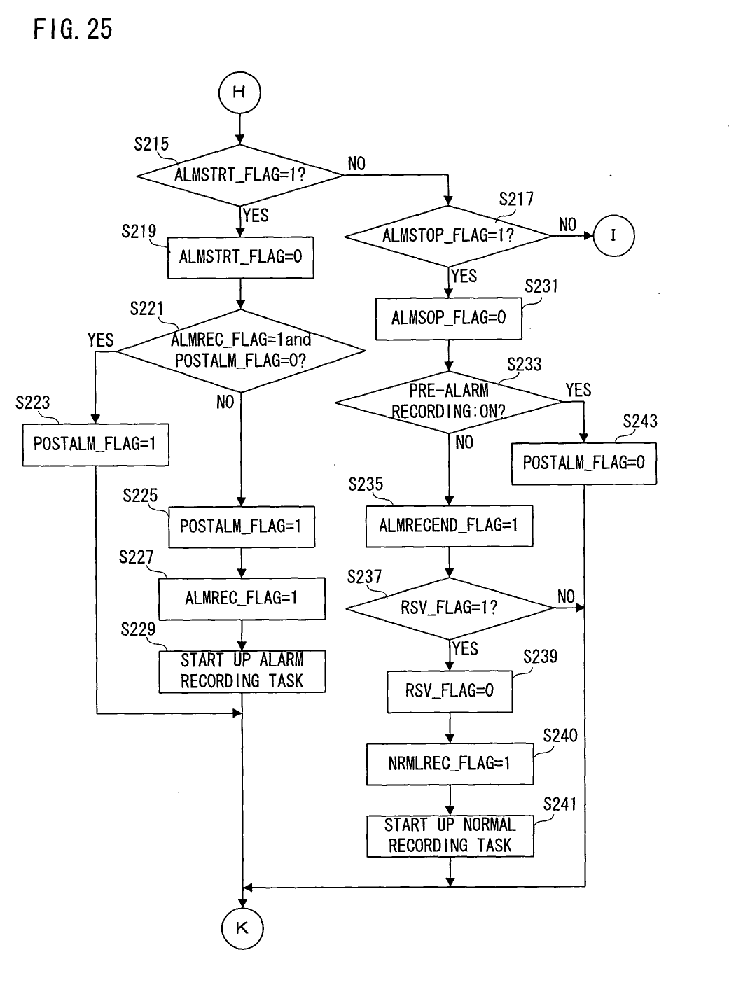

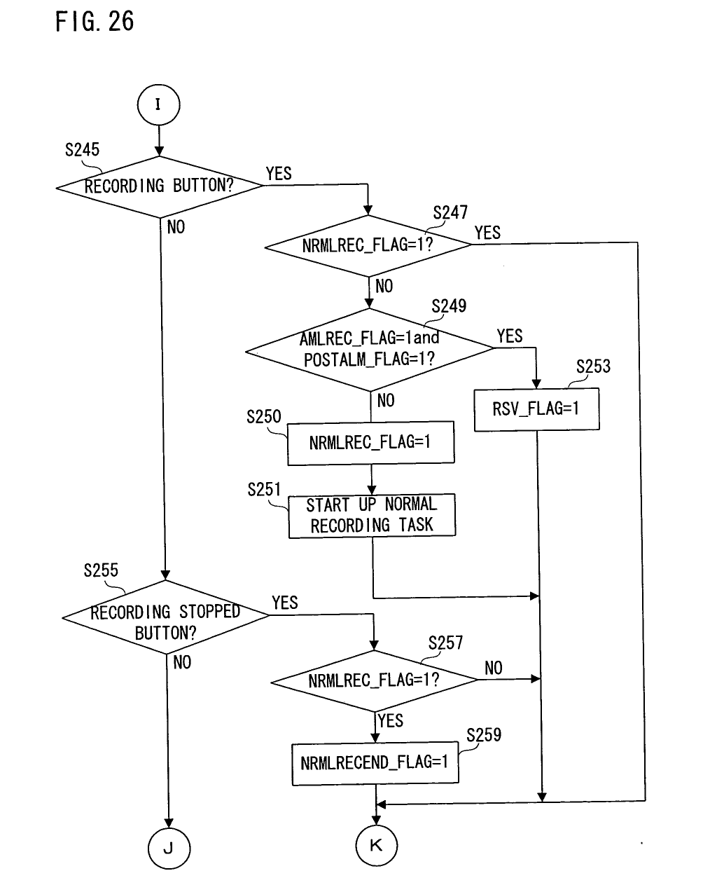

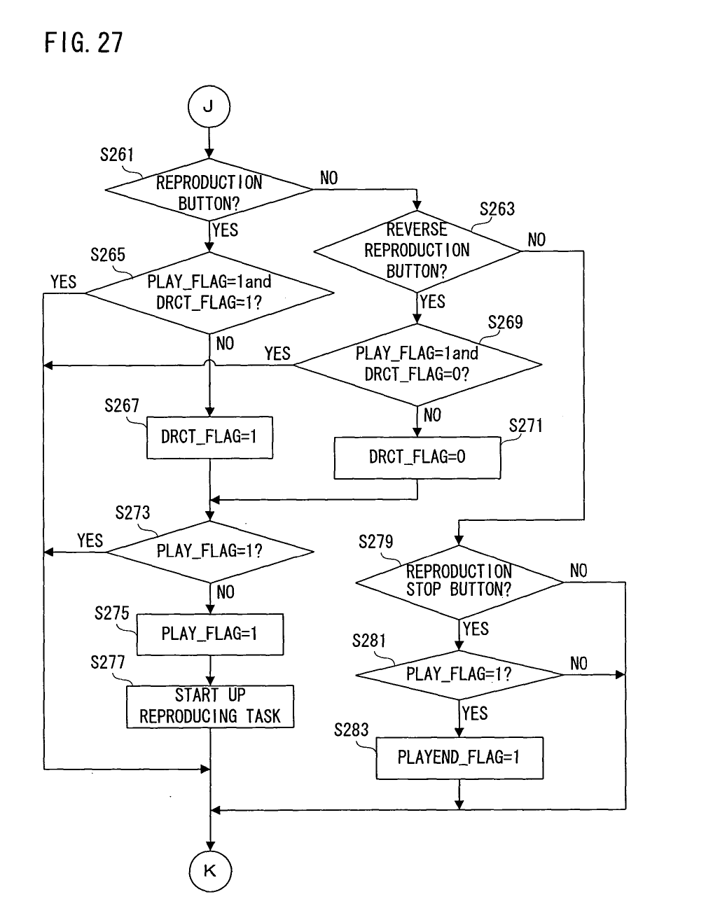

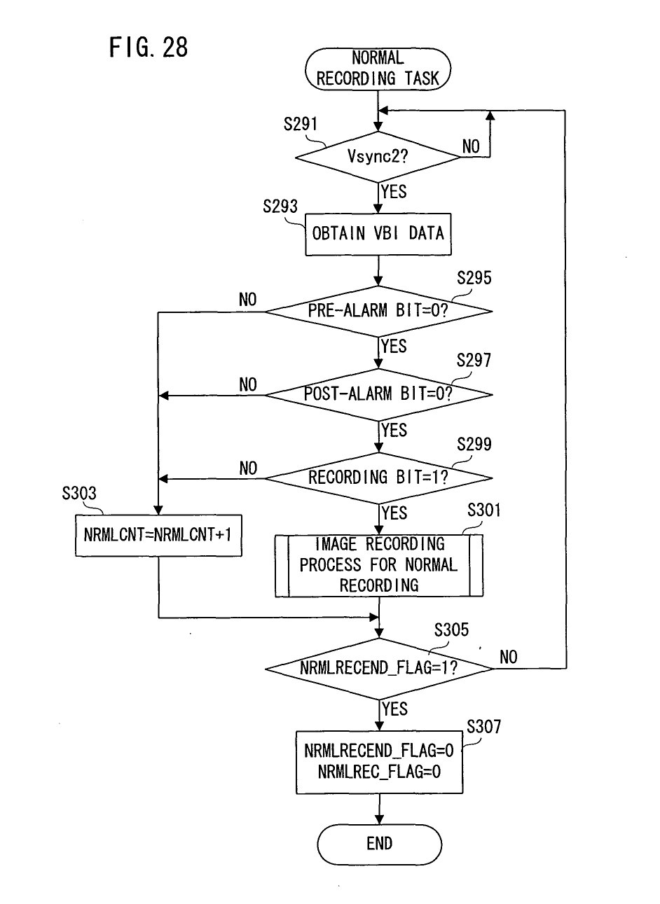

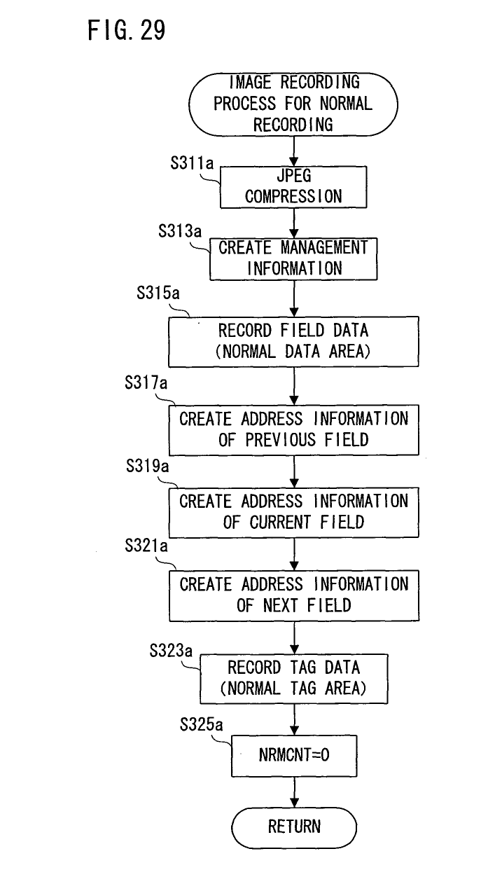

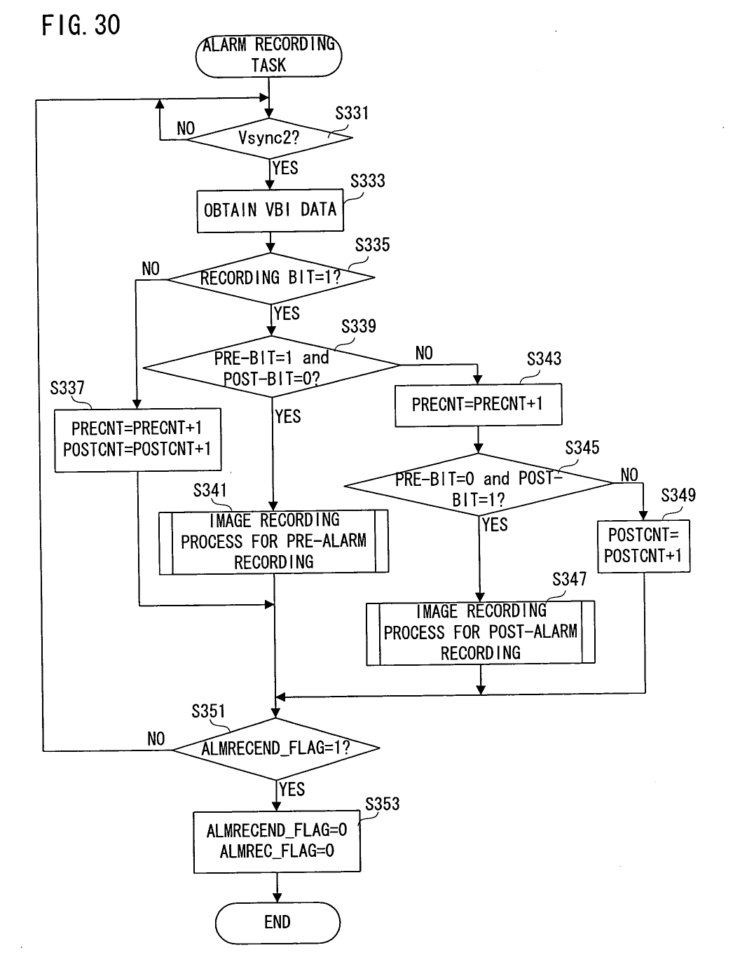

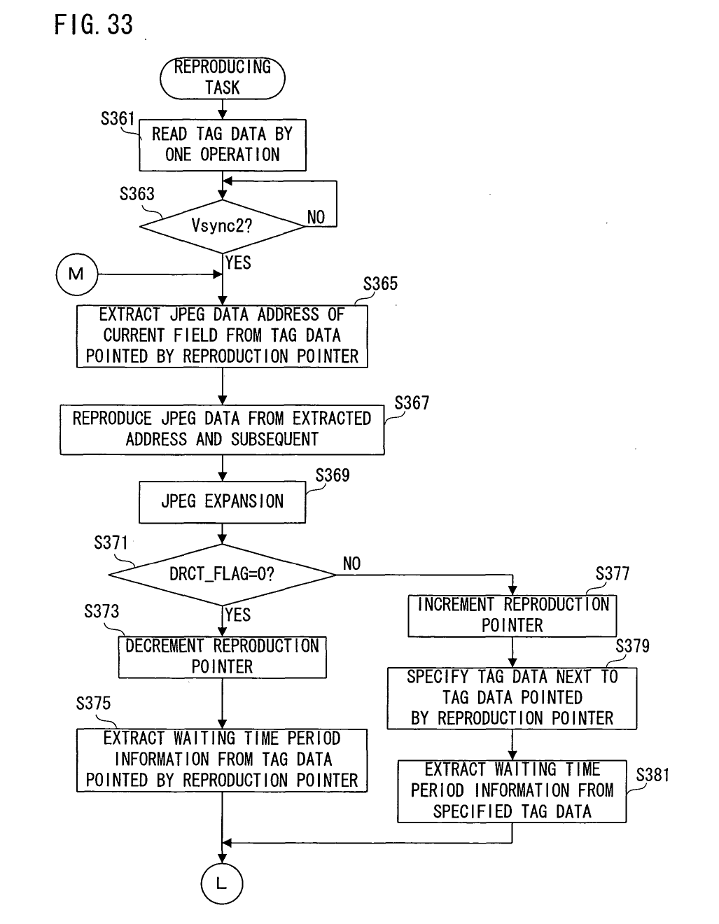

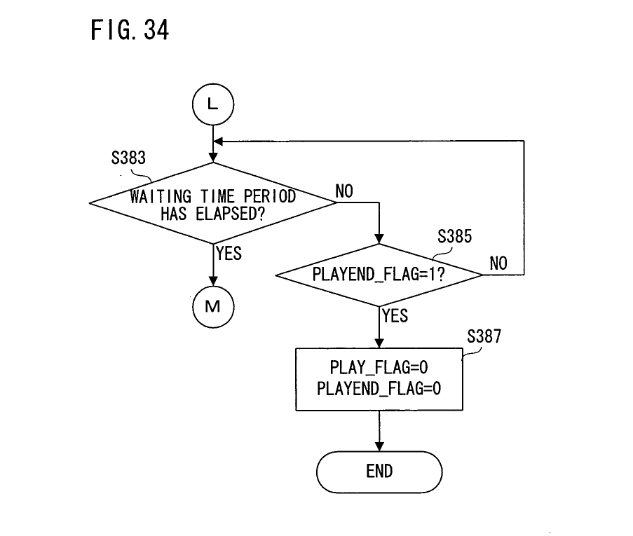

The main CPU 42 of the HDR 16 operates according to the flowcharts shown in FIG. 17 and FIG. 25. The main CPU 42 is a multitask CPU installed with a real-time OS such as μI TRON, and a main task shown in FIG. 24 to FIG. 27, a normal recording task shown in FIG. 28 and FIG. 29, an alarm recording task shown in FIG. 30 to FIG. 32 and a reproducing task shown in FIG. 33 and FIG. 34 are executed in parallel with each other. It is noted that the control program corresponding to the flowcharts is stored in a ROM 42a.

Referring to FIG. 24, first, the ON/OFF state of the pre-alarm recording mode is determined in a step S201, states of variables ALMREC_FLAG and POSTALM_FLAG are determined in a step S213, and a state of the variable ALMREC_FLAG is determined in a step S205. Herein, the variable ALMREC_FLAG is a variable for determining whether or not the alarm recording task is started up, and “0” indicates a stop state while “1” indicates a start-up state. The variable POSTALM_FLAG is a variable for determining whether the pre-alarm recording is being executed or the post-alarm recording is being executed, and “0” indicates the pre-alarm recording while “1” indicates the post-alarm recording.

When the pre-alarm recording mode is in the on setting, and the variable ALMREC_FLAG is “0”, it is considered to be immediately after the power-ON or immediately after the pre-alarm recording mode being changed from the off setting to the on setting. Then, the variable ALMREC_FLAG is set to “1” in a step S207, the variable POSTALM_FLAG is set to “0” in a step S209, and the alarm recording task is started up in a step S211. After completion of the process in the step S211, then, the process is returned to the step S201.

If the variable ALMREC_FLAG is “1” and the variable POSTALM_FLAG is “0” irrespective of the pre-alarm recording mode being in the off setting, it is considered to be immediately after the pre-alarm recording mode being changed from the on setting to the off setting, and a variable ALMERCEND _FLAG is set to “1” in a step S214. The variable ALMERCEND _FLAG is a variable for requiring completion or continuation of the alarm recording task, and “1” indicates a completion request while “0” indicates a continuation request. The variable ALMERCEND _FLAG is set to “1” in the step S214, and whereby, the alarm recording task is completed as described later. After completion of the process in the step S214, the process returns to the step S201.

In a case the pre-alarm recording mode is in the on setting, and the alarm recording task has been started up, the process proceeds to a step S115 through the steps S201 and S205. In a case the pre-alarm recording mode is in the off setting and the alarm recording task is in the stop state, or in a case the pre-alarm recording mode is in the off setting and the post-alarm recording is being executed by the alarm recording task, the process proceeds to a step S215 through the step S201 and a step S213.

A state of a variable ALMSTART_FLAG is determined in the step S215. The variable ALMSTART_FLAG is a variable for determining whether or not the alarm occurs, and “0” indicates a non-alarm occurring state while “1” indicates an alarm occurring state. It is noted that renewal of the variable ALMSTART_FLAG from “0” to “1” is performed by that another task (not shown). That is, when a change of the post-alarm bit included in the VBI information from “0” to “1” is detected by that another task, the variable ALMSTART_FLAG is renewed from “0” to “1”.

If “YES” is determined in the step S215, the variable ALMSTART_FLAG is returned to “0” in a step S219, and the states of the variables ALMREC_FLAG and POSTALM_FLAG are determined in a step S221. If the alarm recording task has been started up and the pre-alarm recording is being executed, the variable ALMREC_FLAG indicates “1” and the variable POSTALM_FLAG indicates “0”. At this time, “YES” is determined in the step S221, and the variable POSTALM_FLAG is changed from “0” to “1” in a step S223. Therefore, the recording process in the alarm recording task is changed from the pre-alarm recording to the post-alarm recording. After completion of the process in the step S223, the process returns to the step S201.

On the other hand, if the alarm recording task is not started up because of the pre-alarm recording mode being in the off setting, the variable ALMREC_FLAG indicates “0”. At this time, the variable POSTALM_FLAG is set to “1” in a step S225, the variable ALMREC_FLAG is set to “1” in a step S227, and the alarm recording task is started up in a step S229. After completion of the process in the step S229, the process returns to the step S201.

If “NO” is determined in the step S215, the state of a variable ALMSTOP_FLAG is determined in a step S217. The variable ALMSTOP_FLAG is the variable for determining whether or not the alarm is stopped, and “0” indicates the alarm occurring state while “1” indicates an alarm stopped state.

It is noted that the renewal of the variable ALMSTOP_FLAG from “0” to “1” is also performed by another task (not shown). That is, when the change of the post-alarm bit included in the VBI information from “1” to “0” is detected by that another task, the variable ALMSTART_FLAG is renewed from “1” to “0”.

If “YES” is determined in the step S217, the variable ALMSTOP_FLAG is returned to “0” in a step S231, and the ON/OFF setting of the pre-alarm recording mode is determined in a step S233. When the pre-alarm recording mode is in the on setting, the variable POSTALM_FLAG is returned from “1” to “0” in a step S243. Therefore, the recording process in the alarm recording task is switched from the post-alarm recording to the pre-alarm recording. After completion of the process in the step S243, the process is returned to the step S201.

When the pre-alarm recording mode is in the off setting, “NO” is determined in the step S233, and the variable ALMRECEND_FLAG is set to “1” in a step S235 so as to require an end of the alarm recording task. In a following step S237, it is determined whether or not a variable RSV_FLAG is “1”. The RSV_FLAG is a variable for determining whether or not a start of the normal recording after completion of the post-alarm recording is reserved, and “1” indicates presence of a reservation while “0” indicates absence of the reservation.

If “NO” is determined in the step S237, the process directly returns to the step S201. On the other hand, if “YES” is determined in the step S237, the variable RSV_FLAG is returned to “0” in a step S239, a variable NRMLREC_FLAG is set to “1” in a step S240, and then, the normal recording task is started up in a step S241. Herein, the variable NRMLREC_FLAG is a variable for determining start-up/stop of the normal recording task, and “1” indicates a start-up state while “0” indicates a stopped state. After completion of the process in the step S241, the process returns to the step S101.

If “NO” is determined in the step S217, it is determined whether or not the recording button 44b is operated in a step S245 shown in FIG. 19. If “YES” is determined herein, the process proceeds to a step S247 so as to identify a state of the variable NRMLREC_FLAG. If NRMLREC_FLAG=1, it is considered that the normal recording task has been started up, and the process is returned from the step S247 to the step S201. On the other hand, if NRMLREC_FLAG=0, it is considered that the normal recording task is in the stopped state, and the states of the variables ALMREC_FLAG and POSTALM_FLAG are determined in a step S249.

If the alarm recording task is not started up, the variable ALMREC_FLAG indicates “0”. Furthermore, if the alarm recording task is started up while the pre-alarm recording is being executed, the variables ALMREC_FLAG and POSTALM_FLAG indicate “1” and “0”, respectively. At this time, “YES” is determined in the step S249, and the variable NRMLREC_FLAG is set to “1” in a step S250, and the normal recording task is started up in a step S251. After completion of the process in the step S251, the process returns to the step S201.

On the one hand, if the post-alarm recording is being executed in the alarm recording task, the variables ALMREC_FLAG and POSTALM_FLAG indicate “1”. At this time, the variable RSV_FLAG is set to “1” in a step S253, and then, the process returns to the step S201.

It is determined whether or not the recording stop button 44c is operated in a step S255, and if “YES” is determined, the state of the NRMLREC_FLAG is determined in a step S257. If NRMLREC_FLAG=0, it is considered that the normal recording task is in the stopped state, and the process directly returns to the step S201. On the contrary thereto, if NRMLREC_FLAG=1, it is considered that the normal recording task is in the start-up state, and a variable NRMLRECEND_FLAG is set to “1” in a step S259. The variable NRMLRECEND_FLAG is a variable for requiring completion or continuation of the normal recording task, and “1” indicates a completion request while “0” indicates a continuation request. The variable NRMLRECEND_FLAG is set to “1” in the step S259, and whereby the normal recording task is completed as described later. After completion of the process in the step S259, the process returns to the step S201.

If “NO” is determined in the step S255, it is determined whether or not the reproduction button 44d is operated in a step S261 shown in FIG. 20. If “YES” is determined herein, states of variables PLAY_FLAG and DRCT_FLAG are determined in a step S265. The variable PLAY_FLAG is a variable for determining start-up/stop of the reproducing task, and “1” indicates the start-up while “0” indicates the stop. Furthermore, the variable DRCT_FLAG is a variable for determining a reproducing direction, and “0” indicates a forward direction while “1” indicates a reverse direction.

If the reproduction in the forward direction is being executed by the reproducing task, each of the variables PLAY_FLAG and DRCT_FLAG indicates “1”. At this time, “YES” is determined in the step S265, and then, the process directly returns to the step S201. On the other hand, if the reproducing task is in the stopped state, the variable PLAY_FLAG indicates “0”, and if the reproduction in the reverse direction is being executed by the reproducing task, the variable PLAY_FLAG indicates “1”, and the variable DRCT_FLAG indicates “0”. In such a case, “NO” is determined in the step S265, and the variable DRCT_FLAG is set to “1” in a step S267.

A state of the variable PLAY_FLAG is determined in a step S273. Herein, if the PLAY_FLAG=1, it is considered that the reproducing task has been started up and then, the process directly proceeds to the step S201. On the other hand, if PLAY_FLAG=0, it is considered that the reproducing task is in the stopped state, the variable PLAY_FLAG is changed to “1” in a step S275, and the reproducing task is started up in a step S277. After completion of the process in the step S277, the process proceeds to the step S201.

It is determined whether or not the reverse reproduction button 44e is operated in a step S263, and if “YES”, the states of the variables PLAY_FLAG and DRCT_FLAG are determined in a step S269. If the reproduction in the reverse direction is being executed by the reproducing task, the variable PLAY_FLAG indicates “1” and the variable DRCT_FLAG indicates “0”. At this time, “YES” is determined in the step S269, and the process directly returns to the step S201. On the other hand, when the reproducing task is in the stopped state, the variable PLAY_FLAG indicates “0”, and when the reproduction in the forward direction is being executed by the reproducing task, both of the variables PLAY_FLAG and DRCT_FLAG indicate “1”. At this time, “NO” is determined in the step S269, and the variable DRCT_FLAG is set to “0” in a step S271 and then, the process proceeds to a step S273.

It is determined whether or not the reproduction stop button 44f is operated in a step S279, and if “YES” is determined, the state of the variable PLAY_FLAG is determined in a step S281. If PLAY_FLAG=0, it is considered that the reproducing task is in the stopped state and then, the process directly returns to the step S201. On the other hand, if PLAY_FLAG=1, it is considered that the reproducing task is in the start-up state and then, a variable PLAYEND_FLAG is set to “1” in a step S283. The variable PLAYEND_FLAG is a variable for requiring continuation or completion of the reproducing task, and “0” indicates a continuation request while “1” indicates a completion request. The variable PLAYEND_FLAG is set to “1” in the step S283, and whereby the reproducing task is stopped as described later. After completion of the process in the step S283, the process returns to the step S201.

Referring to FIG. 28, in the normal recording task, it is determined whether or not a vertical synchronization signal Vsync2 occurs in a step S291. The vertical synchronization signal Vsync2 is a timing signal generated every 1/30 seconds within the HDR 16. Therefore, “YES” is determined every 1/30 seconds in the step S291. In a step S293, the VBI information is obtained from the RAM 36 shown in FIG. 12, and in a following steps S295 to S299, each of the values of the obtained VBI information is identified.

If both the pre-alarm bit and the post-alarm bit are “0” and the recording bit is “1”, “YES” is determined in all the steps S295 to S299, and a recording process for the normal recording is performed in a step S301 and then, the process proceeds to a step S305. On the contrary thereto, any one of the above-described conditions is not satisfied, a variable NRMCNT is incremented in a step S303, and then, the process proceeds to the step S305. The variable NRMCNT is the number of the successive fields of image data which is not an object of the normal recording.

In the step S305, a state of the variable NRMLRECEND_FLAG is determined, and as long as NRMLRECEND_FLAG=0, the process in the steps S291 to S305 is repeated. If NRMLRECEND_FLAG=1, “YES” is determined in the step S305, and the variables NRMLRECEND_FLAG and NRMLREC_FLAG are set to “0” in a step S307. After completion of the process in the step S307, the reproducing task is stopped.

The image recording process in the step S301 is complies with a subroutine shown in FIG. 29 in the step S301. First, in a step S311a, the JPEG codec 46 shown in FIG. 12 is instructed to perform a JPEG compression on the photographed image data stored in the input image area 56a shown in FIG. 13(A). The JPEG codec 46 reads the photographed image data from the input image area 56a through the memory I/F circuit 54, generates the JPEG data by the JEPG compression, and writes via the memory I/F circuit 54 the generated JPEG data to the compressed image area 56b shown in FIG. 13 (A)

In a step 313a, the management information including a photographing date, a JPEG size, an alarm number, a camera ID, a recording field number, a waiting time period information and etc. is created, and the created management information is written to the management information area 56c shown in FIG. 13 (A). Out of these, the waiting time period information corresponds to the variable NRMCNT+1.

In a step S315a, the HDD 50 is instructed to record the management information and the JPEG data related with each other in the normal data area 52d (see FIG. 14). The management information and the JPEG data related with each other are applied to the HDD 50 via the memory I/F circuit 54 and the drive I/F circuit 48 and recorded in the normal data area 52d by the HDD 50. The management information and the JPEG data are recorded in the normal data area 52d as shown in FIG. 15 (A). Therefore, the field data is created.

The address information of the previous field is created in a step S317a, the address information of the current field is created in a step S319a, and the address information in the next field is created in a step S 321a. Explaining in detail, the head address of the management information and the head address information of the JPEG data are detected with respect to the filed data of the previous field in the step S317a, the head address of the management information and the head address information of the JPEG data are detected with respect to the filed data of the current field in the step S319a, and the head address of the management information and the head address information of the JPEG data are detected with respect to the filed data of the next field in the step S 321a.

In a step S323a, the tag data including the management information created in the step S313a and the addresses detected in the steps S317a to S321a are created, and the HDD 50 is requested to record the created tag data in the normal tag area 52c. The tag data is recorded in the normal tag area 52c by the HDD 50. In a step S325a, the variable NRMLCNT is reset and thereafter, the process is restored to an upper hierarchical routine.

Referring to FIG. 30, in the alarm recording task, the same process as the above-described steps S291 and S293 are executed in steps S331 and S333. The recording bit included in the extracted VBI information is determined in a step S335, and if the recording list is “0”, variables PRECNT and POSTCNT are incremented in a step S337 and then, the process proceeds to a step S351. It is noted that the variable PRECNT indicates the number of the successive fields of the image data which is not an object to be subjected to the pre-alarm recording, and the variable POSTCNT indicates the number of the successive fields of the image data which is not an object to be subjected to the post-alarm recording.

If it is determined that the recording list is “1” in the step S335, the pre-alarm bit and the post-alarm bit are identified in a step S339. If the pre-alarm bit and the post-alarm bit are “1” and “0”, respectively, “YES” is determined in the step S339, an image recording process for the pre-alarm recording is performed in a step S341 and then, the process proceeds to the step S351. On the other hand, if “NO” is determined in the step S339, the variable PRECNT is incremented in a step S343, and then, the process proceeds to a step S345.

In the step S345, the pre-alarm bit and the post-alarm bit are determined again. If the pre-alarm bit and the post-alarm bit are “0” and “1”, respectively, “YES” is determined in the step S345, an image recording process for the pos-alarm recording is performed in a step S347, and then, the process proceeds to the step S351. If “NO” is determined in the step S345, the variable POSTCNT is incremented in a step S349, and then, the process proceeds to the step S351.

A state of the variable ALMRECEND_FLAG is determined in the step S351, and so long as ALMRECEND_FLAG=0, the process from the steps S331 to S351 is repeated. If ALMRECEND_FLAG=1, the variables ALMRECEND_FLAG and ALMREC_FLAG are set to “0” in a step S353. After completion of the process in the step S353, the alarm recording task is stopped.

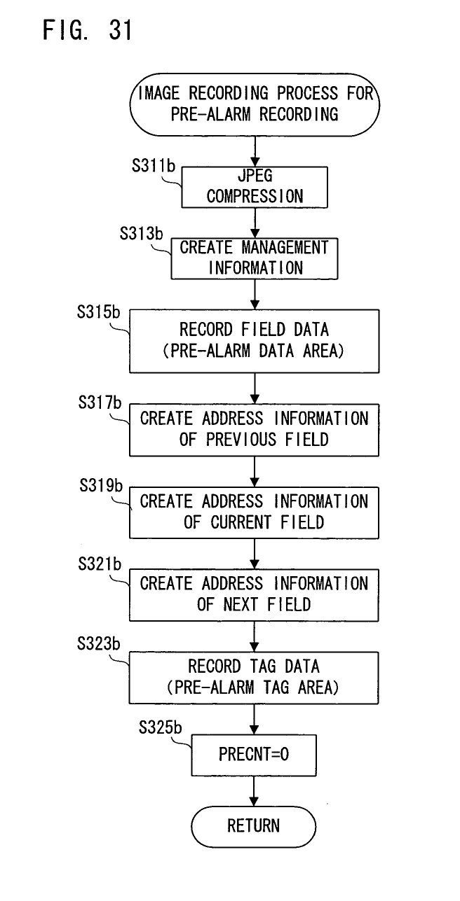

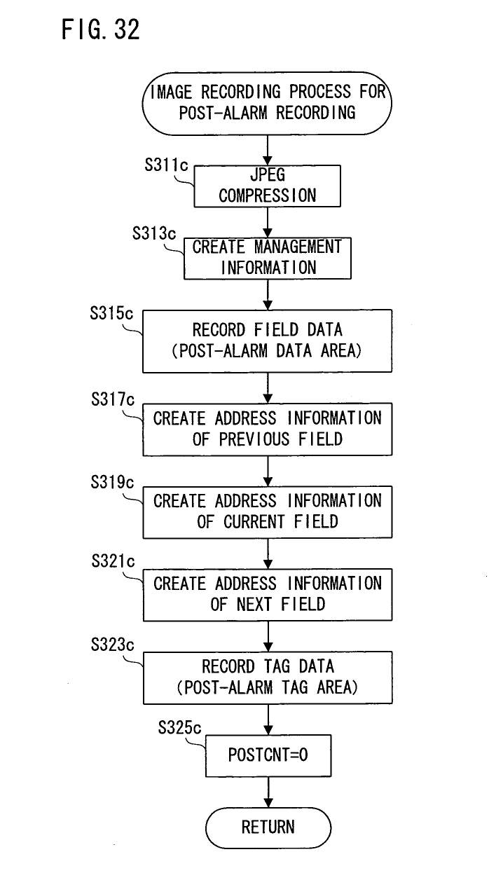

The image recording process in the step S341 complies with a subroutine shown in FIG. 31, and the image recording process in the step S347 complies with a subroutine shown in FIG. 32.

It is noted that the subroutine shown in FIG. 31 is the same as the subroutine shown in FIG. 29 except that the waiting time period information created in a step S313b corresponds to the variable PRECNT+1, the field data is recorded in the pre-alarm data area 52h in a step S315b, the tag data is recorded in the pre-alarm tag area 52g in a step S323b, and the variable PRECNT is reset in a step S325b. The subroutine shown in FIG. 32 is the same as the subroutine shown in FIG. 29 except that the waiting time period information created in a step S313c corresponds to the variable POSTCNT+1, the field data is recorded in the post-alarm data area 52j in a step S315c, and the tag data is recorded in the pre-alarm tag area 52i in a step 323c, and the variable POSTCNT is reset in a step S325c. Accordingly, a description is omitted as to the subroutines shown in FIG. 31 and FIG. 32.

Referring to FIG. 33, in the reproducing task, the HDD 50 is requested to read by one operation the tag data from a desired tag area (any one of the normal tag area 52c, the pre-alarm tag area 52g and the post-alarm tag area 52i) formed in the hard disk 52 in a step S361. The tag data is read by one operation from the desired area by the HDD 52 and transferred to the SDRAM 56. The tag data read by the HDD 50 is stored in the tag data area 56fshown in FIG. 13(B). It is noted that the tag data of an arbitrary field stored in the tag data area 56fis pointed by a reproducing pointer.

It is determined whether or not the vertical synchronization signal Vsync2 is generated in a step S363, and if “YES” is determined, the process proceeds to a step S365. Therefore, the process in the step S365 and the subsequent is executed at every 1/30 seconds. The head address of the JPEG data of the current field is extracted from the tag data pointed by the reproducing pointer in the step S365, and the HDD 50 is requested to reproduce the JEPG data of the distracted head address and the subsequent in a step S367. The JPEG data is read by the HDD 50 and stored in the compressed image area 56e(see FIG. 13 (B)) of the SDRAM 56.

An expansion process of the JPEG data stored in the compressed image area 56eis instructed to the JPEG codec 46 in a step S369. The JPEG codec 46 reads the JPEG data from the compressed image area 56e, performs the JPEG expansion on the read JPEG data and writes expanded photographed image data to the output image area 56d shown in FIG. 13 (B). The photographed image data is then converted to a photographed image signal in the video decoder 38 and output to the monitor 22 via the multiplexer 14. Consequently, a reproduced image is displayed on the monitor screen.

The variable DRCT_FLAG is determined in a step S371. If DRCT_FLAG=1, it is considered that a reproducing direction at this time is the forward direction and then, the reproducing pointer is incremented in a step S377. The reproducing pointer points the tag data of the next field. Tag data next to the tag data pointed by the incremented reproducing pointer (tag data of a field next to the next field) is specified in a step S379, and the waiting time period information is extracted from the specified tag data in a step S381.

On the other hand, if DRCT_FLAG=0 is determined, it is considered that the reproducing direction at this time is a reverse direction, and the reproducing pointer is decremented in a step S373. The reproducing pointer points the tag data of the previous field. In a step S375, the waiting time period information is extracted from the tag data pointed by the reproducing pointer which has been decremented.

It is determined whether or not the waiting time period indicated by the extracted waiting time period information has elapsed, and if “YES”, the process returns to the step S365. Consequently, the photographed image data is reproduced in the forward or reverse direction at the same speed (normal speed) as that in recording. If “NO” is determined in a step S383, it is determined whether or not the variable PLAYEND_FLAG indicates “1” in a step S385. If the PLAYEND_FLAG is “1”, it is considered that completion of the reproduction is required, and the variables PLAY_FLAG and PLAYEND_FLAG are set to “0” in a step S387. The reproducing task is stopped after completion of the process in the step S387.

As can be understood from the above-description, the camera switch circuit 22a or 22b included in the multiplexer 14 selects any of the plurality of the surveillance cameras C1 to C 16 in a time-division manner. The image processing circuit 24a or 24b fetches the photographed image signal output from the selected surveillance camera, and adds the VBI information having the recording bit of “1” to the photographed image signal at a timing according to the recording mode setting. The HDR 16 records the image signal in the hard disk 52 when the recording bit included in the VBI information is “1”. Accordingly, it is possible to precisely record only the desired photographed image signal in the hard disk 52.

Furthermore, the multiplexer 14 selectively fetches the photographed image signals 1 to 16 of the plurality of fields output from the surveillance cameras C1 to C16 and extracts the photographed image signal of an arbitrary field (screen) at a timing according to the recording mode setting. The extracted photographed image signal is recorded in the hard disk 52 by the HDR 16. The HDR 16 detects a time difference between a timing of the extraction in the previous time and a timing of the extraction in the current time by the multiplexer 14 and records a detected time difference value as the time period information in the hard disk 52. Reproducing timing of the photographed image signal recorded in the hard disk 52 is controlled on the basis of the waiting time period information. Therefore, it is possible to reproduce the photographed image signal from the hard disk 52 at a desired speed irrespective of an extraction cycle of the photographed image signal.

It is noted that although the multiplexer and the HDR are integrated with each other in this embodiment, the multiplexer and the HDR may be separated from each other. Furthermore, if another video recorder having only the HDR is cascaded to the video recorder of this embodiment, data exceeding a capacity of the hard disk can be recorded. In a case of adding another video recorder, an advantage of recording control in the present invention conspicuously appears.

In addition, although the hard disk is adopted as a recording medium in this embodiment, it is not restricted to the disk recording medium so long as it is superior in a random access characteristic. Therefore, a semiconductor memory may be utilized as the recording medium.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image recording system, comprising:
a multiplexer for selectively outputting a plurality of image signals applied from a plurality of cameras; and
a recording apparatus for recording the image signals output from said multiplexer in a recording medium, wherein said multiplexer includes a selector for selecting each of said plurality of cameras in a time-division manner, an applier for applying at an arbitrary timing a recording request signal to the image signal output from a camera selected by said selector, and said recording apparatus includes a recorder for recording, when the recording request signal is applied to the image signal output from said multiplexer, the image signal in said recording medium.

2. An image recording system according to claim 1, wherein said multiplexer further includes an accepter for accepting setting of a recording rate with respect to each of said plurality of cameras, and the arbitrary timing is a timing according to the recording rate setting accepted by said accepter.

3. An image recording system according to claim 1, wherein said multiplexer further includes a recording mode information generator for generating recording mode information indicative of any one of pre-alarm recording and post-alarm recording depending upon an occurring state of an alarm, and the recording request signal includes the recording mode information generated by said recording mode information generator.

4. An image recording system according to claim 3, wherein said recording medium has a pre-alarm area and a post-alarm area, and said recorder includes a detector for detecting the recording mode information from the recording request signal, a pre-alarm recorder for recording the image signal in said pre-alarm area when the recording mode information detected by said detector indicates the pre-alarm recording, and a post-alarm recorder for recording the image signal in said post-alarm area when the recording mode information detected by said detector indicates the post-alarm recording.

5. An image recording system according to claim 1, wherein said selector selects by priority a specific camera when performing post-alarm recording.

6. An image recording reproducing apparatus, comprising:
an extractor for extracting an image signal of an arbitrary screen from image signals of a plurality of successive screens;
a first recorder for recording the image signal extracted by said extractor;
a detector for detecting a time difference value between a previous extraction timing by said extractor and a current extraction timing by said extractor;
a second recorder for recording control information including the time difference value detected by said detector; and
a reproducer for reproducing the image signal recorded by said first recorder at a timing based on the control information recorded by said second recorder.

7. An image recording reproducing apparatus according to claim 6, further comprising a selector for selecting each of a plurality of cameras in a time-division manner, wherein the image signals of the plurality of the successive screens are image signals output from a camera selected by said selector.

8. An image recording reproducing apparatus according to claim 6, wherein said second recorder relates the control information including the time difference value to the image signal currently extracted by said extractor.

9. An image recording reproducing apparatus according to claim 8, further comprising:
a first difference value detector for detecting a first time difference value included in the control information related to an image signal of a next screen when reproducing an image signal of a current screen; and
a second difference value detector for detecting, when reproducing the image signal of the current screen, a second time difference value included in the control information related to the image signal; wherein said reproducer includes a first normal speed reproducer for reproducing the image signal of the next screen at a time that a time period corresponding to the first time difference value has elapsed when performing normal speed reproduction in a forward direction, and a second normal speed reproducer for reproducing the image signal of the previous screen at a time that a time period corresponding to the second time difference value has elapsed when performing normal speed reproduction in a reverse direction.
